(19) United States
(12) Patent Application Publication
(10) Pub. No.: US 2006/0069650 A1
(43) Pub. Date: Mar. 30, 2006

(54) Device and method for reproducing encrypted contents

(75) Inventor: Yoshihiro Hori, Gifu-City (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/239,103

(22) Filed: Sep. 30, 2005

(30) Foreign Application Priority Data
Sep. 30, 2004 (JP) 2004-288813
Sep. 14, 2005 (JP) 2005-267058

(51) Int. Cl. G06Q 99/00

(52) U.S. Cl. 705/57

(57) ABSTRACT

The present invention provides a technique for improving the convenience of the user while protecting the copyright of contents. A device receives contents usage right information from a storage device, and decrypts encrypted contents data using a contents key contained in the contents usage right information thus received. At this time, the device stores status information which indicates the use state of the contents usage right information. Furthermore, the device measures elapsed time for decryption of the encrypted contents data using the contents key, or elapsed time for reproduction of the contents data decrypted using the contents key. The device determines whether or not the contents usage right information has been used, based upon the elapsed time thus measured. Then, the device updates the status information stored in a log storage device, based upon the determination result.

### BACKGROUND OF THE INVENTION

1. Field of the Invention

The present invention relates to a contents reproducing technique, and particularly to a contents reproducing device for decrypting and reproducing encrypted contents and a method thereof.

2. Description of the Related Art

As a copyright protection method for protecting contents data, a contents management method is well known in which contents data is encrypted, and contents usage right information (which will be referred to as “license data” hereafter) including a decryption key (which will be referred to as “contents key” hereafter) for decrypting the encrypted contents data is managed with high security (see Patent document 1, for example). With a contents data distribution system disclosed in Patent document 1, examples of the devices handling the license data in a non-encrypted form includes three devices of a server device, a memory card serving as a storage device, and a decoder serving as a user device. With such a contents data distribution system, an encrypted commination path is established between the server device and the storage device, and between the storage device and the user device. With such a configuration, the license data is exchanged through the encrypted communication path. Each of the server device, the storage device, and the user device, includes a TRM (Tamper Resistant Module) for handling encrypted license data.

With establishment of the encrypted communication path, first, a device providing license data (which will be referred to as “license provider”) transmits a certificate including a public key to a device receiving the license data (which will be referred to as “license receiver”). Then, the license provider verifies the certificate. As a result of the verification, only in a case that determination has been made that the certificate received from the license provider is valid, and is not listed in the certificate revocation list, key sharing is performed between the two devices using the public key included in the certificate. Then, the license provider transmits the license data, which has been encrypted using a key transmitted from the license provider to the license receiver, to the license receiver. The TRM is a circuit module which physically protects the security thereof. The TRM has a configuration which does not allows access from external circuits, except through the encrypted communication path.

Note that in a case of acquisition of the license data, the memory card, which is mounted to a terminal device having a function of communication with the server, receives the license data from the server through the terminal device. On the other hand, in a case of using contents, the memory card, which is mounted to the terminal device including a built-in decoder, transmits the license data to the decoder through the terminal device.

Furthermore, with such a system, the memory card has a function for restricting the output of the license data according to restriction information contained in the license data. For example, the license data contains control information which indicates the number of times that reproduction of the contents data is permitted using the license data. At the time of reproduction, the memory card checks the restriction information, i.e., the number of times reproduction is permitted, contained in the license data, thereby determining whether or not the license data permits output thereof. The control information is updated for each output of the license data. In a case that the number of times of reproduction has reached the limit due to repeated reproduction, the output of the license data is forbidden.

As described above, such a contents distribution service provides encryption of the contents data and security of the license data, thereby ensuring copyright protection with regard to the contents. Furthermore, the contents distribution service employs usage restriction such as reproduction-times control, thereby enabling the contents distribution service to be applied to various services. Such ensuring of the contents copyright protection protects the right of the contents copyright holder, thereby enabling the contents to be provided with high security. This helps increase in the contents added to the lineup for contents distribution service, thereby meeting the needs of the user over a wider range.

Conventional contents distribution systems as described above have the problems as follows. That is to say, let us say that the storage device transmits the license data with reproduction-times restriction to the reproducing device, but the reproducing device does not use the license data for the purpose of reproduction. Even in this case, the user uses up the right of one-time reproduction. Furthermore, even in a case that only a part of the contents is reproduced for the purpose of sample listening, the user uses up the right of one-time reproduction, as well.
Patent document 1: WO01/43342

### SUMMARY OF THE INVENTION

The present invention has been made in view of the aforementioned problems. Accordingly, it is an object thereof to provide a technique for improving the convenience of the user while protecting the copyright of the contents.

The present invention has the features as follows in view of the aforementioned problems.

With a contents reproducing device for decrypting and reproducing encrypted contents data using contents usage right information containing a contents key for decrypting the encrypted contents data stored in a storage device according to an aspect of the present invention, the contents reproducing device comprises: an interface controlling transmission/reception of data to/from the storage device; a contents decryption unit for decrypting the encrypted contents data using the contents key contained in the contents usage right information; a contents key output unit for receiving the contents usage right information from the storage device, and outputting the contents key contained in the contents usage right information to the contents decryption unit; a log storage unit for storing status information which indicates the use state of the contents usage right information; and a determining unit for acquiring the elapsed time for which the encrypted contents data has been decrypted by the contents decryption unit using the contents key, or the elapsed time for which the contents data, which has been decrypted by the contents decryption unit using the contents key, has been reproduced, determining whether or not the contents key has been used based upon the elapsed time thus acquired, and updating the status information stored in the log storage unit based upon the determination results.

With the aforementioned aspect, in a case that the elapsed time for reproduction is too short to determine that the contents key has been used, the status information stored as log information is updated based upon the status information indicating that the contents key has not been used. This improves the convenience of the user while protecting the copyright of the contents.

The contents reproducing device may further include an elapsed-time measurement unit for measuring the elapsed time and notifying the determining unit of the elapsed time. Furthermore, an arrangement may be made in which the elapsed-time measuring unit measures the elapsed time from the start of decryption or reproduction processing after output of the contents key from the contents key output unit to the contents decryption unit. With such an arrangement, in a case that the elapsed time has exceeded a predetermined period of time, the determining unit determines that the contents key has been used.

The contents reproducing device may further include an elapsed-time measurement unit for measuring the elapsed time and notifying the determining unit of the elapsed time. Furthermore, an arrangement may be made in which the elapsed-time measurement unit calculates the elapsed time based upon the amount of data decrypted by the contents decryption unit, or based upon the reproduced data amount of the encrypted contents data thus decrypted, and notifies the determining unit of the elapsed time thus calculated. With such an arrangement, in a case that the elapsed time has exceeded a predetermined period of time, the determining unit determines that the contents key has been used.

An arrangement may be made in which the predetermined period of time is included in the contents usage right information, and the contents key output unit outputs the predetermined period of time included in the contents usage right information thus received, to the determining unit. The predetermined period of time may be set to 45 seconds.

The contents reproducing device may further include a control unit. With such an arrangement, in a case that the determining unit has determined that the contents key has not been used, the control unit requests the storage device to restore the contents usage right information stored in the storage device to the previous state in which the contents reproducing device has not yet received the contents usage right information.

An arrangement may be made in which in a case that the control unit requests the storage device to restore the contents usage right information to the previous state in which the contents reproducing device has not yet received the contents usage right information, the control unit transmits log information containing the status information stored in the log storage unit to the storage device. The log information may be used for determination whether or not the storage device is permitted to restore the contents usage right information.

The control unit may transmits a hash value of information containing a shared key shared between the contents reproducing device and the storage device, as well as transmitting the log information. The hash value may be used by the storage device for determining the validity of the contents reproducing device.

An arrangement may be made in which upon reception of the contents usage right information, the log storage unit stores at least a part of the contents usage right information without change. With such an arrangement, in a case that the control unit requests the storage device to restore the contents usage right information to the previous state in which the contents reproducing device has not yet received the contents usage right information, the control unit transmits the contents usage right information stored in the log storage unit without change, to the storage device.

Another aspect of the present invention relates to a contents usage reproducing method. The contents usage reproducing method for decrypting and reproducing encrypted contents data using contents usage right information containing a contents key for decrypting the encrypted contents data stored in a storage device comprises: receiving the contents usage right information from the storage device, and decrypting the encrypted contents data using the contents key contained in the contents usage right information thus received; storing status information which indicates the use state of the contents usage right information in a log storage unit; and acquiring the elapsed time for which the encrypted contents data has been decrypted using the contents key, or the elapsed time for which the contents data, which has been decrypted using the contents key, has been reproduced, determining whether or not the contents key has been used based upon the elapsed time thus acquired, and updating the status information stored in the log storage unit based upon the determination results.

An arrangement may be made in which the elapsed time is measured using a timer from the start of decryption or reproduction processing. With such an arrangement, in a case that the elapsed time has exceeded a predetermined period of time, determination is made that the contents key has been used. Also, an arrangement may be made in which the elapsed time is calculated based upon the decrypted data amount or the reproduced data amount of the encrypted contents data thus decrypted. With such an arrangement, in a case that the elapsed time has exceeded a predetermined period of time, determination is made that the contents key has been used. The predetermined period of time may be included in the contents usage right information. The predetermined period of time may be set to 45 seconds.

An arrangement may be made in which in a case that determination has been made that the contents key has not been used, the storage device is requested to restore the contents usage right information stored therein to the previous state in which the contents usage right information has not yet been received.

An arrangement may be made in which in a case that a contents reproducing device for decrypting and reproducing the encrypted contents data has requested the storage device to restore the contents usage right information to the previous state in which the contents reproducing device has not yet received the contents usage right information, log information containing the status information stored in the log storage unit is transmitted to the storage device. An arrangement may be made in which the storage device determines whether or not restoration of the contents usage right information should be permitted with reference to the log information. With such an arrangement, in a case that determination has been made that restoration should be permitted, the storage device restores the contents usage right information to the previous state. An arrangement may be made in which the storage device also stores status information which indicates the use state of the contents usage right information therein, and the storage device further determines whether or not restoration of the contents usage right information should be permitted with reference to the status information stored therein.

An arrangement may be made in which a hash value of information containing a shared key shared between the contents reproducing device and the storage device is transmitted to the storage device, in addition to the log information. An arrangement may be made in which the storage device makes a confirmation whether or not a contents reproducing device which has requested restoration of the contents usage right information matches a device to which the storage device has transmitted the contents usage right information, with reference to the hash value. With such an arrangement, in a case that the confirmation has been made, the storage device restores the contents usage right information to the previous state.

An arrangement may be made in which in a case of transmission of the contents usage right information from the storage device to the contents reproducing device, the storage device stores at least a part of the contents usage right information without change. With such an arrangement, in a case that the contents reproducing device has requested the storage device to restore the contents usage right information to the previous state, the storage device overwrites the contents usage right information with the contents usage right information stored without change, thereby restoring the contents usage right information to the previous state.

An arrangement may be made in which upon reception of the contents usage right information, the log storage unit stores at least a part of the contents usage right information without change. With such an arrangement, in a case that the storage device has been requested to restore the contents usage right information to the state in which the contents usage right information has not yet been received, the contents usage right information stored in the log storage unit without change is transmitted to the storage device. The storage device may have a function for restoring the contents usage right information to the previous state by overwriting the contents usage right information with the contents usage right information in the previous state.

The features and technological significance of the present invention will become apparent from the following description of the embodiments. It should be clearly understood that the embodiments will be described for exemplary purposes only, and that the meanings of the technical terms given in this description of the present invention or the components thereof by way of embodiments are by no means intended to be interpreted restrictively.

### BRIEF DESCRIPTION OF THE DRAWINGS

FIG. 1 is a diagram which shows a configuration of a data management system according to a first embodiment;

FIG. 2 is a diagram which shows a configuration of a distribution system according to the first embodiment;

FIG. 3 is a diagram which shows a configuration of a distribution system according to the first embodiment;

FIG. 4 is a diagram which shows a configuration of a storage device according to the first embodiment;

FIG. 5 is a diagram which shows a configuration of an cipher engine shown in FIG. 2;

FIG. 6 is a diagram which shows a configuration of an cipher engine shown in FIG. 3;

FIG. 7 is a diagram which shows a configuration of an cipher engine shown in FIG. 4;

FIG. 8 is a diagram for describing recording processing for license data;

FIG. 9 is a diagram for describing the recording processing for the license data;

FIG. 10 is a diagram for describing use processing for the license data;

FIG. 11 is a diagram for describing the use processing for the license data;

FIG. 12 is a diagram for describing the use processing for the license data;

FIG. 13 is a diagram for describing the use processing for the license data; and

FIG. 14 is a diagram which shows a configuration of a distribution system according to a second embodiment.

### DETAILED DESCRIPTION OF THE INVENTION

Description will be made below regarding embodiments with reference to the drawings. With the embodiments, a technique is proposed with regard to a device for decrypting and reproducing encrypted contents data using contents usage right information received from a storage device. With such a technique, in a case that the reproducing device has not reproduced the contents data, or in a case that the reproduction is made within a predetermined period of time, the control information included in the contents usage right information regarding reproduction stored in the storage device is restored to the previous state where the contents usage right information has not been output. With such a technique in which reproduction is made using the license data having reproduction-times restriction, determination is made that the license has not been used up for some kinds of reproduction such as reproduction for seeking a program, reproduction for the purpose of sample listening, and so forth. This ensures the right of the user for reproducing contents.

### First Embodiment

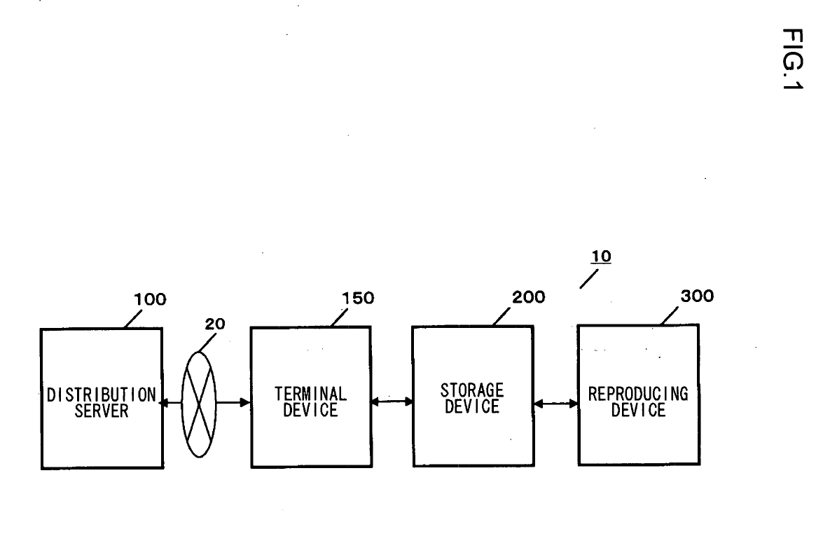

FIG. 1 shows an overall configuration of a data management system 10 according to an embodiment. The data management system 10 includes: a distribution server 100 for sending data; a terminal device 150 for storing the data received from the distribution server 100 in a storage device 200; a reproducing device 300 for reproducing the data stored in the storage device 200; and the storage device 200 for storing and holding data.

The term storage device 200 as used in the present embodiment does not represent a recording medium alone for storing data. Rather, the storage device 200 is a storage device with a built-in drive. The storage device 200 includes a controller and so forth for controlling input/output of data between: a host device such as the terminal device 150, the reproducing device 300, and so forth; and the recording medium. Description will be made in the present embodiment regarding an example employing a hard disk drive as the storage device 200.

In general, conventional hard disk drives are used in the state in which each hard disk drive is fixedly connected to a certain host device. On the other hand, the storage device 200 according to the present embodiment has a configuration which allows the user to detach the storage device 200 from a host device such as the terminal device 150, the reproducing device 300, and so forth. That is to say, with the present embodiment, the user can detach the storage device 200 from the host device in the same way as with CD, DVD, and so forth. Thus, such a function allows the storage device 200 to be shared between multiple host devices such as the terminal device 150 and the reproducing device 300 as well as a recording/reproducing device having both functions of recording and reproducing, and so forth.

As described above, the storage device 200 according to the present embodiment is designed to have a function of being shared between multiple host devices. This may lead a problem that the data stored in the storage device 200 is read out by a third party through an unauthorized host device. Let us say that the storage device 200 stores contents such as audio contents, video contents, and so forth, protected by the copyright, or confidential information such as confidential corporation information, confidential personal information, and so forth. In order to prevent leakage of such kinds of confidential data, the storage device 200 preferably has a proper configuration for protecting the data, i.e., preferably has a sufficient tamper-resistant function.

From such a perspective, the storage device 200 according to the present embodiment has a configuration which allows exchange of confidential data in an encrypted form between the storage device 200 and the host device at the time of input/output of the confidential data therebetween. Furthermore, the storage device 200 has a confidential data storage area separate from an ordinary storage area, for storing confidential data. With such a configuration, no external circuit can access the confidential data storage area except through an cipher engine included in the storage device 200. The cipher engine allows input/output of confidential data to/from a host device, only in a case that the host device has been verified as an authorized host device. Such a data protection function will also be referred to as “secure function” hereafter. The aforementioned configuration and function provide proper protection of the confidential data stored in the storage device 200.

The secure function of the storage device 200 is preferably designed so as to maintain the advantages of serving as a removable medium as much as possible. That is to say, the storage device 200 is preferably designed so as to allow input/output of ordinary data to/from a host device, even if the host device has no secure function. Accordingly, the storage device 200 according to the present embodiment is designed stipulated by ATA (AT attachment) which is a standard of ANSI (American National Standards Institute), thereby maintaining compatibility with conventional hard disks. That is to say, the aforementioned secure function is realized in the form of expanded commands of ATA.

Description will be made below regarding an example of input/output of confidential data in which the contents data such as video contents are recorded and reproduced. While the contents data may be handled as confidential data, description will be made below regarding an arrangement according to the present embodiment in which the contents data is encrypted, and the contents data thus encrypted is stored in the storage device 200 as ordinary data. Furthermore, the system handles a contents key and license data as the confidential data using the aforementioned secure function. Note that the contents key as used here represents a key for decrypting the contents data thus encrypted. On the other hand, the license data as used here represents the data including information (which will be referred to as “user agreement” hereafter) regarding control for reproduction of the contents, and control for the usage, transmission, and duplication of the license. This enables input/output of data in a simple manner while maintaining the sufficient tamper-resistant function, thereby enabling high-speed processing with reduced power consumption.

With the present embodiment, the license data includes identifying information LicID for identifying the license data as well as the contents key and the user agreement. Furthermore, the user agreement includes control information PC for determining the maximum number of times for which output of the license data for the purpose of reproduction thereof is permitted. Let us say that the control information PC is defined as follows. That is to say, the control information PC is represented by an unsigned integer of one byte, which indicates the maximum number of times the license data can be output. With such a configuration, the control information PC is decremented by 1 for each output of the license data. Note that the control information PC of 255 is a special value which indicates that the license data can be reproduced without an upper limit number of times. That is to say, in a case that the control information PC is set to 255, the value of the control information PC is maintained regardless of output of the license data for the purpose of reproduction thereof. Note that the methods for setting and operation of the control information PC according to the present embodiment have been described for exemplary purposes only, and are not restricted in particular.

Of commands issued by the host device such as the distribution server 100, the reproducing device 300, and so forth, to the storage device 200, the expanded commands for the secure function will be referred to as “secure commands” hereafter. On the other hand, the other commands will also be referred to as “ordinary commands” hereafter.

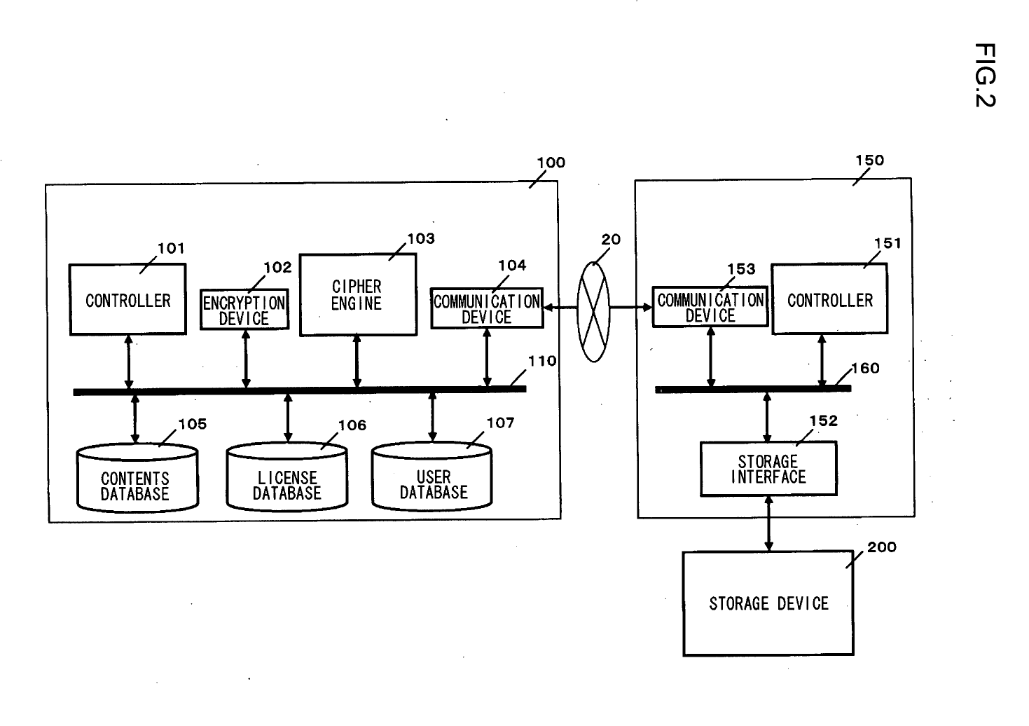

FIG. 2 shows the configurations of the distribution server 100 and the terminal device 150 according to the present embodiment. The distribution server 100 and the terminal device 150 are connected to an Internet 20, which is a network, through communication devices 104 and 153. The distribution server 100 includes an encryption device 102, an cipher engine 103, the communication device 104, a contents database 105, a license database 106, a user database 107, a controller 101 for controlling these components, and a data bus 110 for electrically connecting these components. The configuration of the distribution server 100 may be realized by hardware means, e.g., by actions of a CPU, memory, and other LSIs, of a computer, and by software means, e.g., by actions of a program or the like, loaded to the memory. Here, the drawing shows a functional block configuration realized by cooperation of the hardware components and software components. It is needless to say that such a functional block configuration can be realized by hardware components alone, software components alone, or various combinations thereof, which can be readily conceived by those skilled in this art.

The encryption device 102 issues license data LIC containing a contents key for decrypting encrypted contents. The contents data, which has been encoded by the contents database 105, is encrypted using the contents key. The encrypted contents data is transmitted to the terminal device 150 through the data bus 110 and the communication device 104, and is stored in the storage device 200.

The cipher engine 103 controls encrypted communication with the storage device 200, thereby allowing the license data LIC, which is to be provided to the user, to be stored in the storage device 200. The encrypted communication with the storage device 200 is directly performed through the data bus 110 and the communication device 104 of the distribution server 100, the Internet 20, and the communication device 153, a data bus 160, a controller 151, and a storage interface 152 of the terminal device 150.

The communication device 104 exchanges data with other devices through the Internet 20. Here, the communication device 104 exchanges data with the terminal device 150. The contents database 105 holds contents data which is to be provided to the user. The license database 106 holds the license data containing the contents key used for encrypting the contents data. The user database 107 holds information regarding the user to which the contents data is to be provided. For example, the user database 107 may hold the user private information, the address of the user terminal device 150, the purchase history regarding contents, fee information, and so forth.

The controller 101 of the distribution server 100 reads out contents data from the contents database 105 in response to the request from the user. Furthermore, the controller 101 reads out the license data LIC from the license database 106. The controller 101 transmits the contents data and the contents key contained in the license data LIC, which has been read out, to the encryption device 102, as well as transmitting the license data LIC to the cipher engine 103. Then, the encryption device 102 encrypts the contents data using the contents key, and transmits the contents data thus encrypted, to the terminal device 150 through the communication device 104. Furthermore, an encrypted communication path is established by the cipher engine 103, through which the license data LIC is transmitted to the terminal device 150. The terminal device 150 stores the license data LIC thus received, in the storage device 200.

Upon storage of the encrypted contents data and the license data LIC in the storage device 200, determination is made that the contents data has been provided to the user through the terminal device 150. In this case, the controller 101 updates the user database 107 for the contents fee of the contents providing service.

The terminal device 150 includes the storage interface 152, the communication device 153, the controller 151 for controlling these devices, and the data bus 160 for electrically connecting these devices. The configuration of the terminal device 150 may be realized by hardware means, e.g., by actions of a CPU, memory, and other LSIs, of a computer, and by software means, e.g., by actions of a program or the like having storage control functions, loaded to the memory. Here, the drawing shows a functional block configuration realized by cooperation of the hardware components and software components. It is needless to say that such a functional block configuration can be realized by hardware components alone, software components alone, or various combinations thereof, which can be readily conceived by those skilled in this art.

The storage interface 152 controls input/output of data to/from the storage device 200. The communication device 153 exchanges data with other devices through the Internet 20. With the present embodiment, the communication device 153 exchanges data with the distribution server 100. The controller 151 of the terminal device 150 transmits the contents distribution request received from the user, to the distribution server 100 through the communication device 153. Then, the controller 151 receives the encrypted contents data and the license data from the distribution server 100 through the communication device 153 in response to the aforementioned contents distribution request. Subsequently, the controller 151 stores these data sets thus received, in the storage device 200 through the storage interface 152.

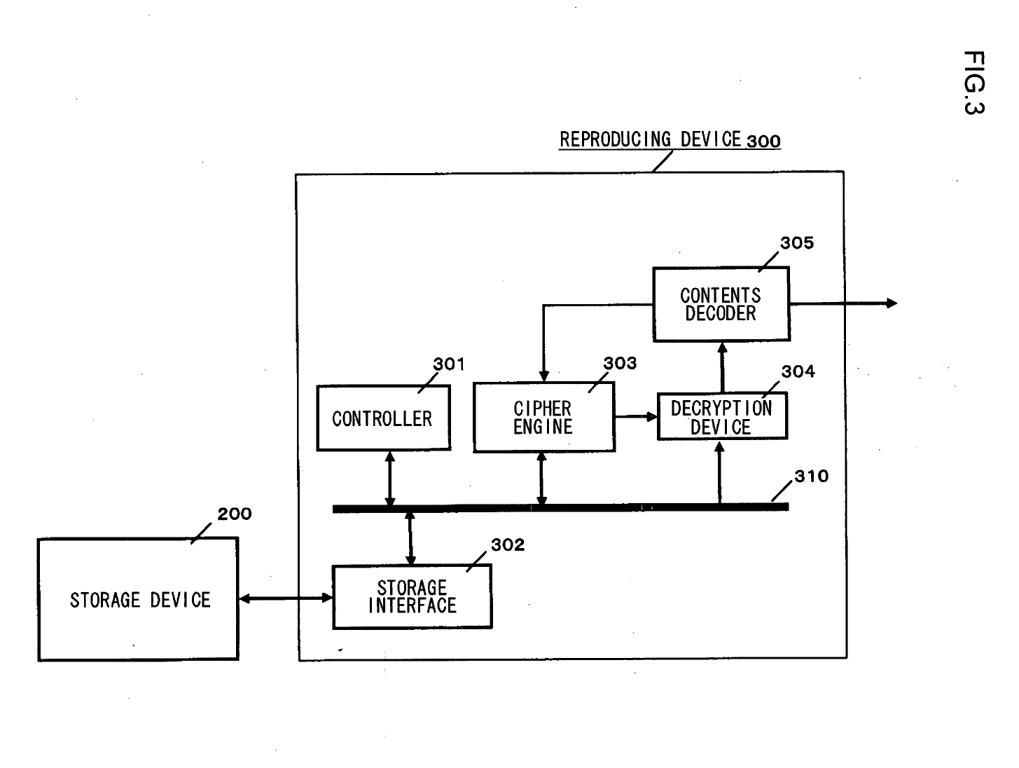

FIG. 3 shows an internal configuration of the reproducing device 300 according to the present embodiment. The aforementioned functional block configuration can be realized by hardware components alone, software components alone, or various combinations thereof. The reproducing device 300 principally includes a controller 301, a storage interface 302, an cipher engine 303, a decryption device 304, a contents decoder 305, and a data bus 310 for connecting these components to each other.

The storage interface 302 controls input/output of data to/from the storage device 200. The cipher engine 303 controls encrypted communication between the storage device 200 and the reproducing device 300, thereby enabling reception of the license data LIC containing the contents key from the storage device 200. The decryption device 304 decrypts the encrypted contents data read out from the storage device 200 using the contents key contained in the license data LIC received from the storage device 200. The contents decoder 305 decodes the contents data decrypted by the decryption device 304, and outputs the decoded contents data. Let us say that the contents data is encoded in the MPEG format. In this case, the contents decoder 305 reproduces the video signal and the audio signal from the contents data. The video signal thus reproduced is displayed on an unshown display device. On the other hand, the audio signal thus reproduced is output to an unshown speaker. The controller 301 centrally controls the components of the reproducing device 300.

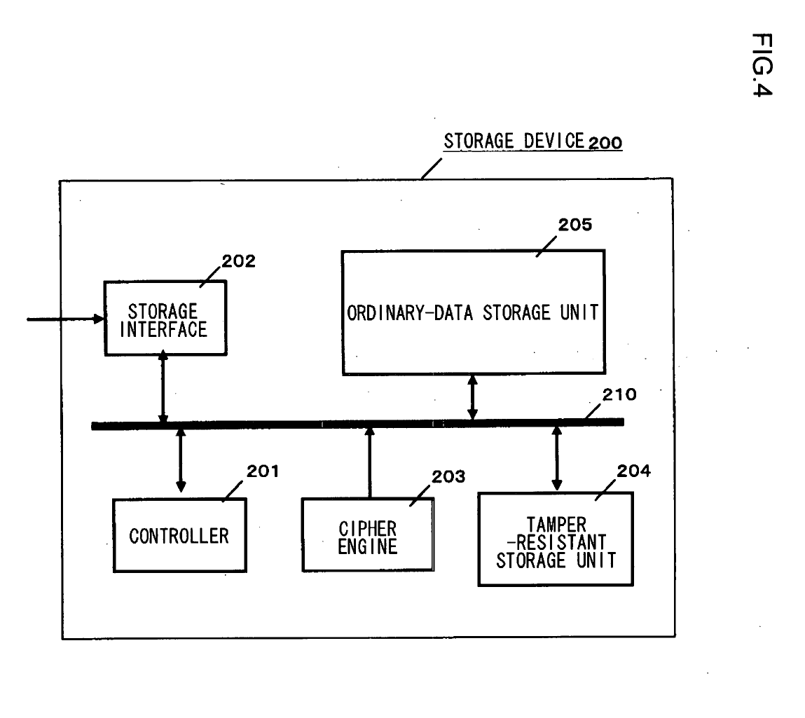

FIG. 4 shows an internal configuration of the storage device 200 according to the present embodiment. The storage device 200 principally includes a controller 200, a storage interface 202, an cipher engine 203, a tamper-resistant storage unit 204, an ordinary-data storage unit 205, and a data bus 210 for connecting these components to each other.

The storage interface 202 controls input/output of data to/from the distribution server 100 and the reproducing device 300. The cipher engine 203 controls encrypted communication between: the storage device 200; and the distribution server 100 and the reproducing device 300, thereby enabling input/output of confidential data such as the license data LIC containing the contents key to/from the distribution server 100 and the reproducing device 300. The ordinary-data storage unit 205 serves as an ordinary-data storage area for storing the encrypted contents data, ordinary data, and so forth. On the other hand, the tamper-resistant storage unit 204 serves as a confidential-data storage area for storing confidential data such as the license data LIC containing the contents key. The ordinary-data storage unit 205 has a configuration which allows direct access from external circuits (input/output of data). On the other hand, the tamper-resistant storage unit 204 has a configuration which does not allow access from external circuits (input/output of data), except through the cipher engine 203. The controller 201 centrally controls these components of the storage device 200.

Now, description will be made regarding the keys employed in the present embodiment. In the present embodiment, all the keys are represented by text strings beginning with a capital K. Furthermore, a symmetric key (shared key) is represented by a text string in which the second letter is a lowercase “c”, “s”, or “r”. More specifically, a challenge key is represented by a text string in which the second letter is a lowercase “c”. Note that the challenge key is a temporary symmetric key created by a transmitter of the license data. Also, a session key is represented by a text string in which the second letter is a lowercase “s”. Note that the session key is a temporary symmetric key created by a receiver of the license data. Also, a recovery key is represented by a text string in which the second letter is a lowercase “r”. Note that the recovery key is a temporary symmetric key created by a receiver of the license data. On the other hand, a public key is represented by a text string in which the second letter is a capital “P”. Also, a private key forming a pair along with the public key is always prepared, which is represented by a text string in which the second letter, i.e., the capital “P” is stripped from the text string representing the public key.

Furthermore, the key prepared for each device group is represented by a text string containing a lowercase “d”. On the other hand, the key prepared for each device is represented by a text string containing a lowercase “p”. These keys are prepared in the form of a pair of a public key and a private key. Note that the public key KPdx for each group is provided in the form of a public key certificate C[KPdx] including a digital signature.

On the other hand, the last letter of each text string which represents a key, e.g., the numeral “2” in the text string KPd2 representing a public key, serves as an index for identifying the cipher engine from which the key has been provided. In the present embodiment, the key provided by a specified cipher engine is represented by a text string in which the last letter is a numeral “1”, “2”, or “3”. On the other hand, the keys provided by unspecified components other than the aforementioned cipher engines are represented by text strings in which the last letter is a letter of the English alphabet such as “x”, “y”, and so forth. In the present embodiment, the key provided by the cipher engine 103 of the distribution server 100 is represented by the index numeral “1”. The key provided by the cipher engine 203 of the storage device 200 is represented by the index numeral “2”. The key provided by the cipher engine 303 of the reproducing device 300 is represented by the index numeral “3”.

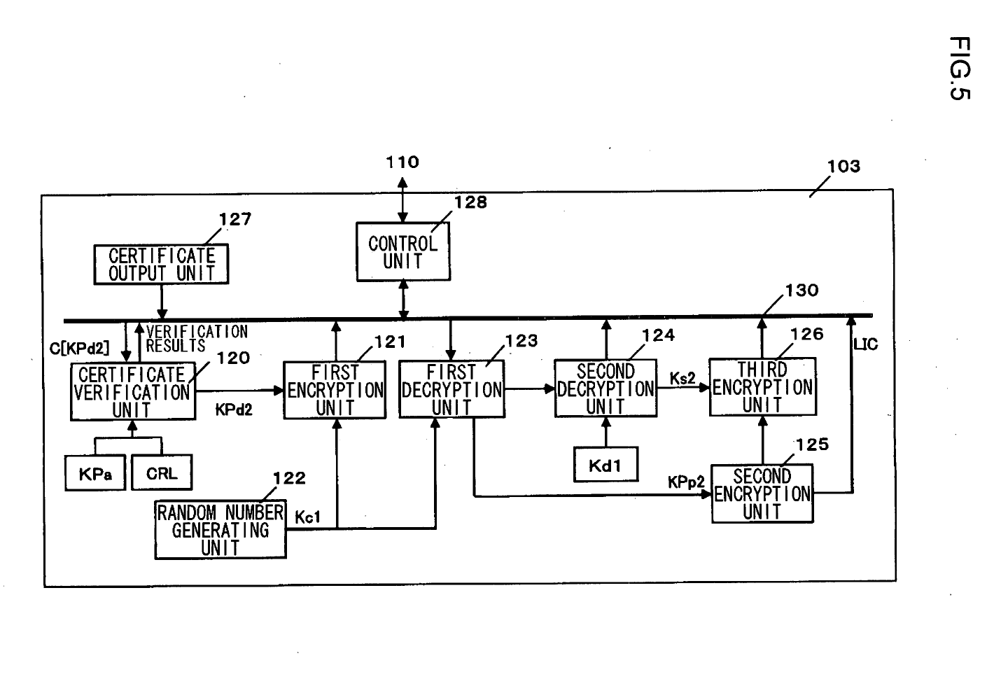

FIG. 5 shows an internal configuration of the cipher engine 103 of the distribution server 100 shown in FIG. 2. The cipher engine 103 includes a certification verification unit 120, a first encryption unit 121, a random number generating unit 122, a first decryption unit 123, a second decryption unit 124, a second encryption unit 125, a third encryption unit 126, a certificate output unit 127, a control unit 128, and a local bus 130 for electrically connecting at least a part of these components to each other.

The certificate verification unit 120 verifies the certificate C[KPd2] acquired from the storage device 200. The certificate C[KPd2] is formed of unencrypted information (which will be referred to as “certificate body” hereafter) containing the public key KPd2, and a digital signature appended to the certificate body. The digital signature is created as follows. That is to say, first, the certificate body is subjected to computation using the hash function (which will be referred to as “hash computation” hereafter). Next, the computation result thus obtained is encrypted using a root key Ka held by an Certificate Authority (not shown) which is a third party organization, thereby creating the digital signature. Note that the root key Ka is a non-public key which is strictly managed by the Certificate Authority. That is to say, the root key Ka is a private key of the Certificate Authority. The certificate verification unit 120 holds a verification key KPa which forms a pair with the root key Ka. The verification key KPa is a public key for verifying the validity of the certificate. The verification of the certificate is made based upon the validity of the certificate, which is to say that the certificate has not been forged, and that the certificate has not been revoked.

That the certificate has not been forged is confirmed based upon comparison results between: the computation result obtained by performing hash function computation for the certificate body of the certificate which is to be verified; and the computation result obtained by decrypting the digital signature using the verification key KPa. In a case that these results match one another, the certificate verification unit 120 determines that the certificate has not been forged. Furthermore, the certificate verification unit 120 holds a certificate revocation list (which will be abbreviate to “CRL”) which is a list of revoked certificates which accordingly have been invalidated. In a case that determination has been made that the certificate which is to be verified is not listed in the CRL, the certificate verification unit 120 determines that the certificate has not been revoked. In the present embodiment, such processing for determining whether or not the certificate is valid, i.e., the certificate has not been forged and revoked, and authenticating the valid certificate, will be referred to as “verification”.

Upon success of verification, the certificate verification unit 120 acquires the public key KPd2 of the storage device 200. Then, the certificate verification unit 120 transmits the public key KPd2 to the first encryption unit 121, as well as making notification of the verification results. In a case of failure in verification, the certificate verification unit 120 outputs a verification error notification.

The certificate output unit 127 outputs a certificate C[KPd1] of the distribution server 100. The certificate is formed of a certificate body containing the public key KPd1 of the distribution server 100 and a digital signature appended to the certificate body. The digital signature is encrypted using the root key Ka of Certificate Authority in the same way as with the certificate of the storage device 200.

The random number generating unit 122 generates a challenge key Kc1 temporarily used for encrypted communication between the distribution server 100 and the storage device 200. The random number generating unit 122 generates the challenge key Kc1 each time that encrypted communication is performed, thereby minimizing the risk of the challenge key being cracked. The generated challenge key Kc1 is transmitted to the first encryption unit 121, and the first decryption unit 123.

In order to notify the storage device 200 of the challenge key Kc1, the first encryption unit 121 encrypts the challenge key Kc1 using the public key KPd2 of the storage device 200 acquired by the certificate verification unit 120, thereby creating an encrypted challenge key E(KPd2, Kc1). Then, the encrypted challenge key E(KPd2, Kc1) is linked to the certificate C[KPd1] output from the certificate output unit 127, thereby creating challenge information E(KPd2, Kc1)//C[KPd1].

Here, the symbol “//” represents data linking. For example, Expression E(KPd2, Kc1)//C[KPd1] represents a data sequence in which the encrypted challenge key E(KPd2, Kc1) and the certificate C[KPd1] are serially linked with each other. On the other hand, the symbol “E” represents an encryption function. For example, Expression E(KPd2, Kc1) represents a function for encrypting the challenge key Kc1 using the public key KPd2.

The first decryption unit 123 decrypts the encrypted data using the challenge, key Kc1. A session key Ks2 issued by the storage device 200 and a public key KPp2 held by the storage device 200 are supplied from the storage device 200 in the form of session information E(Kc1, E(KPd1, Ks2)//KPp2). With the present embodiment, the first decryption unit 123 decrypts the session information using the challenge key Kc1 generated by the random number generating unit 122, thereby acquiring the encrypted session key E(KPd1, Ks2) and the public key KPp2. The public key KPp2 and the encrypted session key E(KPd1, Ks2) thus acquired are transmitted to the second encryption unit 125 and the second decryption unit 124, respectively.

The second decryption unit 124 decrypts the encrypted session key E(KPd1, Ks2) received from the first decryption unit 123, which has been encrypted using the public key KPd1 of the distribution server 100, using the private key Kd1 which forms a pair with the public key KPd1, thereby acquiring the session key Ks2. The session key Ks2 thus acquired is transmitted to the third encryption unit 126.

The second encryption unit 125 acquires the license data LIC containing the contents key issued in the processing in which the encryption device 102 encrypts the contents. Then, the second encryption unit 125 encrypts the license data LIC using the public key KPp2 of the storage device 200 which is a receiver of the license data, thereby creating E(KPp2, LIC). Subsequently, E(KPp2, LIC) thus created is transmitted to the third encryption unit 126.

The third encryption unit 126 further encrypts E(KPp2, LIC) transmitted from the second encryption unit 125 using the session key Ks2 issued by the storage device 200, thereby creating encrypted license data E(Ks2, E(KPp2, LIC)).

The control unit 128 controls the components of the internal configuration of the cipher engine 103, as well as controlling input/output of data to/from external circuits, according to instructions from the controller 101 of the distribution server 100. Note that in FIG. 5, the connection between the control unit 128 and each component within the encryption unit 103 is omitted.

As shown in FIG. 5, the present embodiment has a configuration which does not allow the cipher engine 103 to exchange data with external circuits, except through the control unit 128. While various arrangements can be conceived for connecting these components, the present embodiment has a configuration in which the keys used in the cipher engine 103 such as the challenge key Kc1 generated by the random number generating unit 122, the session key Ks2 received from the storage device 200, and the private key Kd1 of the distribution server 100, are not directly available to external circuits. This prevents leakage of each key, which is to be used within the cipher engine 103, to external circuits through the other components of the distribution server 100, thereby improving security thereof.

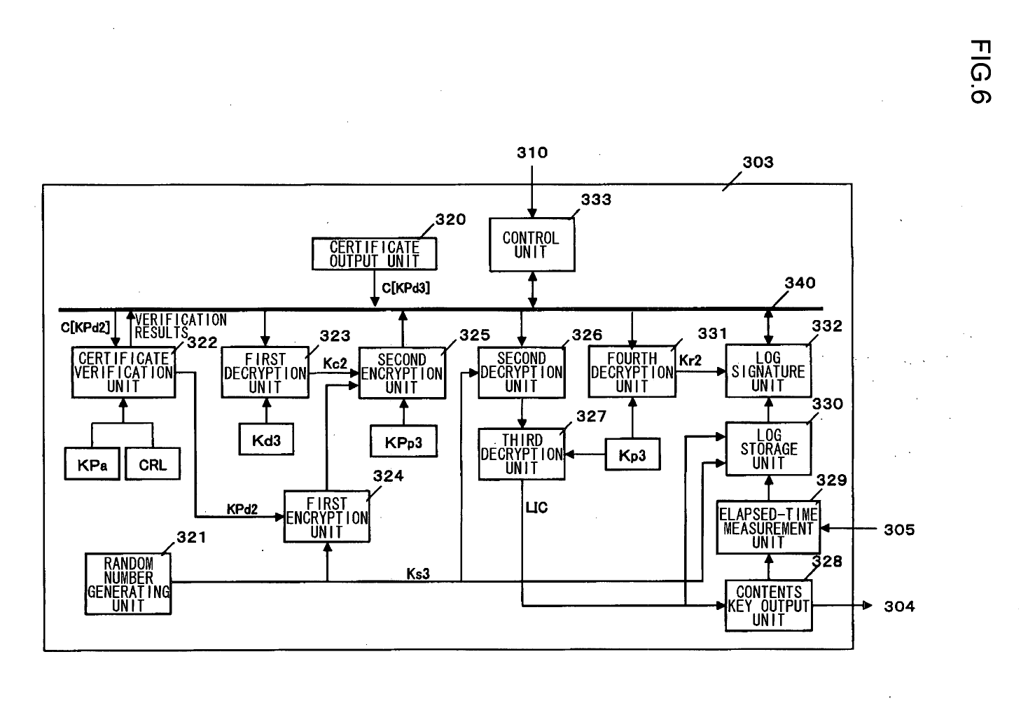

FIG. 6 shows an internal configuration of the cipher engine 303 of the reproducing device 300 shown in FIG. 3. The cipher engine 303 includes: a certificate output unit 320, a random number generating unit 321, a certificate verification unit 322, a first decryption unit 323, a first encryption unit 324, a second encryption unit 325, a second decryption unit 326, a third decryption unit 327, a contents key output unit 328, an elapsed-time measurement 329, a log storage unit 330, a fourth decryption unit 331, a log signature unit 332, a control unit 333, and a local bus 340 for electrically connecting at least part of these components.

The certificate output unit 320 outputs a certificate C[KPd3] of the reproducing device 300. The certificate may be held by the certificate output unit 320. Also, an arrangement may be made in which an unshown certificate holding unit holds the certificate, and the certificate output unit 320 reads out the certificate from the certificate holding unit as necessary. The certificate is formed of the certificate body containing a public key KPd3 of the reproducing device 300 and a digital signature appended to the certificate body. The digital signature is encrypted using the root key Ka of the Certificate Authority in the same way as with the certificate of the storage device 200.

The random number generating unit 321 generates session key Ks3 temporarily used for encrypted communication between the reproducing device 300 and the storage device 200. The created session key Ks3 is transmitted to the first encryption unit 324, the second decryption unit 326, and the log storage unit 330.

The certificate verification unit 322 verifies the certificate C[KPd2] of the storage device 200. The verification is performed as described above in detail.

The first decryption unit 323 decrypts the data, which has been encrypted using the public key KPd3, using a private key Kd3. In reproduction processing, a challenge key Kc2 issued by the storage device 200 is encrypted using the public key KPd3 of the reproducing device 300, and the challenge key Kc2 thus encrypted is supplied from the storage device 200. With the present embodiment, the first decryption unit 323 decrypts the encrypted challenge key Kc2 using the private key Kd3 thereof, thereby acquiring the challenge key Kc2. The challenge key Kc2 thus acquired is transmitted to the second encryption unit 325.

The first encryption unit 324 encrypts data using the public key KPd2 acquired from the certificate C[KPd2] of the storage device 200, thereby creating encrypted data. Specifically, in order to notify the storage device 200 of the session key Ks3, the first encryption unit 324 encrypts the session key Ks3 created by the random number generating unit 321, thereby creating an encrypted session key E(KPd2, Ks3). The encrypted session key E(KPd2, Ks3) thus created is transmitted to the second encryption unit 325.

The second encryption unit 325 encrypts data using the challenge key Kc2 acquired by the first decryption unit 323. Specifically, the second encryption unit 325 performs encryption processing as follows. That is to say, the second encryption unit 325 links the encrypted session key E(KPd2, Ks3) received from the first encryption unit 324 and the public key KPp3 of the reproducing device 300, and encrypts the linked key data, thereby creating session information E(Kc2, E(KPd2, Ks3)//KPp3).

The second decryption unit 326 decrypts the encrypted data using the session key Ks3. The license data LIC is supplied from the storage device 200 in the form of the encrypted license data E(Ks3, E(KPp3, LIC)) in which the license data LIC is encrypted twofold using the public key KPp3 and the session key Ks3. With the present embodiment, the second decryption unit 326 decrypts the encrypted license data E(Ks3, E(KPp3, LIC)) using the session key Ks3 generated by the random number generating unit 321, and transmits the decryption results, i.e., the encrypted license data E(KPp3, LIC) to the third decryption unit 327.

The third decryption unit 327 decrypts the data which has been encrypted using the public key KPp3. Specifically, the third decryption unit 327 decrypts the decryption results received from the second decryption unit 326, i.e., the encrypted license data E(KPp3, LIC) using the private key Kp3 corresponding to the public key KPp3; these keys forming a key pair. Thus, the license data LIC is acquired.

The contents key output unit 328 acquires the contents key from the license data LIC acquired by the third decryption unit 327, and holds the contents key thus acquired. Furthermore, the contents key output unit 328 provides the contents key thus held, to the decryption device 304. Moreover, the contents key output unit 328 monitors decryption processing which uses the contents key, and transmits the state of the processing to the elapsed-time measurement unit 329.

The elapsed-time measurement unit 329 measures reproduction time for which the encrypted contents have been reproduced; the encrypted contents being decrypted using the contents key received from the contents key output unit 328. Furthermore, the elapsed-time measurement unit 329 also has a function serving as a determining unit. That is to say, in a case that the reproduction time has exceeded a predetermined period of time of T seconds, the elapsed-time measurement unit 329 determines that reproduction has been made using the contents key, i.e., the right of one-time reproduction has been used up. Conversely, in a case that reproduction has been canceled before the period of time T, the elapsed-time measurement unit 329 determines that reproduction has not been made using the contents key, i.e., the right of one-time reproduction has not been used up. In other words, in a case that the elapsed time from the start of the reproduction has not exceeded the period of time of T seconds, determination is made that the contents key contained in the license data has not been used. On the other hand, in a case that the elapsed time has exceeded the period of time of T seconds, determination is made that the contents key has been used.

While various configurations may be made for the elapsed-time measurement unit 329, description will be made below regarding an arrangement in which the elapsed time from the start of reproduction is measured using a timer. That is to say, the elapsed-time measurement unit 329 includes a timer. With such an arrangement, upon start of reproduction using the contents key which has been provided from the contents key output unit 328 to the decryption device 304, the elapsed-time measurement unit 329 resets the timer, and starts measurement of the elapsed time. In a case that the elapsed time has reached the predetermined period of time of T seconds, the elapsed-time measurement unit 329 determines that reproduction has been made. Here, the period of time T is a threshold period of time used for determination whether or not the contents have been reproduced, i.e., the license has been used. Note that the period of time T is determined beforehand for each kind of the contents (audio contents, video contents, and so forth). With such an arrangement, let us say that the contents key held by the contents key output unit 328 is discarded before the period of time T, and accordingly, the decryption device 304 cancels decryption processing. In this case, the elapsed-time measurement unit 329 determines that reproduction using the contents key has not been made. Then, information ST3 stored in the log storage unit 330, which will be described later, is updated based upon the determination result. Note that the aforementioned threshold period of time T is set to 45 seconds giving consideration to sample listening of music, for example.

The log storage unit 330 stores history information regarding transmission and consumption of the license data LIC. The history information includes information LicID for specifying the license data LIC, the session key Ks3 which has been created in communication of the license data LIC and which is information for specifying communication of the license data LIC, and the information ST3 for representing the state in a range from communication of the license data up to the consumption thereof (reproduction). Furthermore, the history information may include address information which indicates the address at which the license data has been stored, and the previous control information PC included in the license data.

The information ST3 comprises information indicating one of the states of: the state where the session key has been created (which will be referred to as “state RP” hereafter); the state where the license data LIC has been received (which will be referred to as “state RL” hereafter); and the state where the elapsed-time measurement unit 329 has determined that reproduction has been started (which will be referred to as “state CL” hereafter).

The fourth decryption unit 331 decrypts data which has been encrypted using the public key KPp3. Specifically, the fourth decryption unit 331 decrypts the recovery information E(KPp3, Kr2) received from the storage device 200, using the private key Kp3 which forms a pair with the public key KPp3, thereby acquiring the recovery key Kr2.

The log signature unit 332 creates status information LicID//ST3//H(Kr2//Ks3//LicID//ST3) which indicates the state of reception of the license data LIC, the state of consumption thereof, and so forth in the reproducing device, using the recovery key Kr2 acquired by the fourth decryption unit 331 and the history information stored in the log storage unit 330. The validity of the status information can be verified by the cipher engine 203 which shares the recovery key Kr2 and the session key Ks3 with the reproducing device 300. Here, the symbol H represents the hash function, and Expression H(Kr2//Ks3//LicID//ST3) represents the hash-function computation result in which the hash function is performed for the data Kr2//Ks3//LicID//ST3.

The control unit 333 controls input/output of data between the internal components of the cipher engine 303 and the external components according to instructions from the controller 301 of the reproducing device 300. Note that in FIG. 6, the connection between the control unit 333 and each component within the cipher engine 303 is omitted.

With the cipher engine 303 shown in FIG. 6, while various arrangements can be conceived for connecting these components, the present embodiment has a configuration in which each key cannot be shared between the cipher engine 303 and external circuits, except through the control unit 333. This prevents leakage of the keys to be used within the cipher engine 303, i.e., the session key Ks3 generated by the random number generating unit 321, the private keys Kd3 and Kp3 each of which forms a pair with the corresponding public key, the session key ks2 received from the storage device 200, the recovery key Kr2, and so forth, to external circuits.

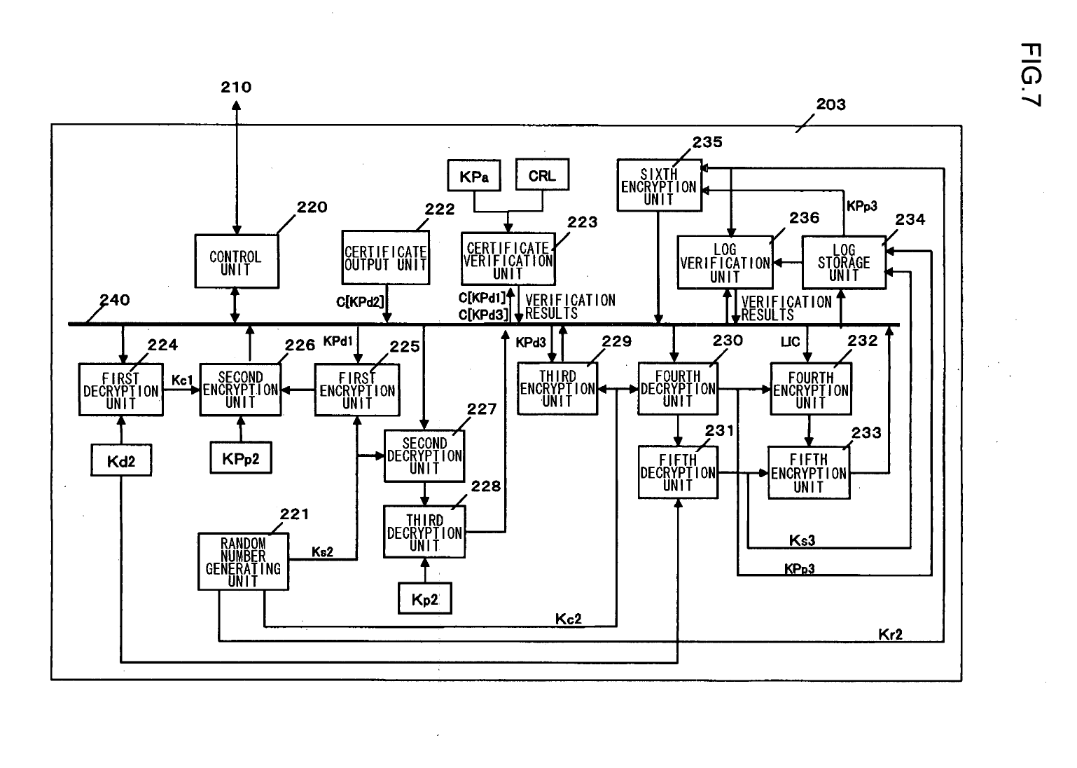

FIG. 7 shows an internal configuration of the cipher engine 203 of the storage device 200 shown in FIG. 4. The aforementioned functional block configuration can also be realized by hardware components alone, software components alone, or various combinations thereof. With the present embodiment, the cipher engine 203 includes a control unit 220, a random number generating unit 221, a certificate output unit 222, a certificate verification unit 223, a first decryption unit 224, a first encryption unit 225, a second encryption unit 226, a second decryption unit 227, a third decryption unit 228, a third encryption unit 229, a fourth decryption unit 230, a fifth decryption unit 231, a fourth decryption unit 232, a fifth encryption unit 233, a log storage unit 234, a sixth encryption unit 235, a log verification unit 236, and a local bus 240 for electrically connecting at least a part of these components.

The control unit 220 controls the internal components of the cipher engine 203 and controls input/output of data to/from external components according to instructions from the controller 201 of the storage device 200.

The random number generating unit 221 generates the session key Ks2, the challenge key Kc2, and the recovery key Kr2 temporarily used for encrypted communication between the storage device 200 and either of the distribution server 100 or the reproducing device 300. Description will be made later regarding the usage of each key.

The certificate output unit 222 outputs the certificate C[KPd2] of the storage device 200. The certificate may be held by the certificate output unit 222. Also, an arrangement may be made in which the certificate is stored in a predetermined storage area in the storage device 200, e.g., the tamper-resistant storage unit 204, and the certificate output unit 222 reads out the certificate therefrom as necessary. The certificate is formed of the certificate body containing the public key KPd2 of the storage device 200 and a digital signature appended to the certificate body. The digital signature is encrypted using the root key Ka of the Certificate Authority.

The certificate verification unit 223 verifies the certificate provided from external components. Specifically, the certificate verification unit 223 verifies the certificate C[KPd1] acquired from the distribution server 100 and the certificate C[KPd3] acquired from the reproducing device 300 using the verification key KPa. Note that the verification is made as described above in detail.

The first decryption unit 224 decrypts the data which has been encrypted using the public key KPd2 of the storage unit 200. Specifically, in a case of recording the data, the challenge key Kc1 issued by the distribution server 100 is encrypted using the public key KPd2 of the storage device 200, and is provided from the distribution server 100. With the present embodiment, the first decryption unit 224 decrypts the encrypted challenge key using the private key Kd2 of the storage device 200, thereby acquiring the challenge key Kc1. The challenge key Kc1 thus acquired is transmitted to the second encryption unit 226.

The first encryption unit 225 encrypts data using the public key KPd1 of the distribution server 100. Specifically, the first encryption unit 225 encrypts the session key Ks2 generated by the random number generating unit 221 using the public key KPd1, thereby creating an encrypted session key E(KPd1, Ks2). The public key KPd1 of the distribution server 100 used here is acquired from the certificate C[KPd1] of the storage device 200 by the control unit 220, and is transmitted through the local bus 240.

The second encryption unit 226 encrypts data using the challenge key Kc1 issued by the distribution server 100. Specifically, the second encryption unit 226 links the encrypted session key E(KPd1, Ks2) received from the first encryption unit 225 and the public key KPp2 of the storage device 200, and encrypts the linked key data using the challenge key Kc1. Thus, the second encryption unit 226 creates session information E(Kc1, E(KPd1, Ks2)//KPp2).

The second decryption unit 227 decrypts the encrypted data using the session key Ks2 generated by the random number generating unit 221. Specifically, the second decryption unit 227 receives the encrypted license data LIC from the distribution server 100 in the form of E(Ks2, E(KPp2, LIC)) in which the license data LIC has been encrypted twofold using the public key KPp2 and the session key Ks2. With the present embodiment, the second decryption unit 227 decrypts the encrypted license data using the session key Ks2, and transmits the decryption results to the third decryption unit 228.

The third decryption unit 228 decrypts the data which has been encrypted using the public key KPp2 of the storage device 200. Specifically, the third decryption unit 228 decrypts the encrypted license data E(KPp2, LIC) received from the second decryption unit 227, using the private key Kp2 of the storage device 200 which forms a pair with the public key KPp2. Thus, the third decryption unit 228 acquires the license data LIC.

The license data LIC thus acquired is supplied to the data bus 210 through the local bus 240 and the control unit 220, and is stored in the tamper-resistant storage unit 204 according to instructions from the controller 201.

The third encryption unit 229 encrypts the data using the public key KPd3 of the reproducing device 300. Specifically, in a case of supplying the license data LIC to the reproducing device 300, the third encryption unit 229 encrypts the challenge key Kc2, which has been generated by the random number generating unit 221, using the public key KPd3 acquired from the certificate C[KPd3] received from the reproducing device 300. Thus, the third encryption unit 229 creates an encrypted challenge key E(KPd3, Kc2). The encrypted challenge key E(KPd3, Kc2) thus created is transmitted to the control unit 220 through the local bus 240. The control unit 220 links the encrypted challenge key E(KPd3, Kc2) and the certificate C[KPd2] of the storage device 200 output from the certificate output unit 222, thereby creating the challenge information E(KPd3, Kc2)//C[KPd2].

The fourth decryption unit 230 decrypts the data using the challenge key Kc2 generated by the random number generating unit 221. Specifically, the fourth decryption unit 230 decrypts the session information E(Kc2, E(KPd2, Ks3)//KPp3) received from the reproducing device 300, using the challenge key Kc2 generated by the random number generating unit 221, thereby acquiring the encrypted session key E(KPd2, Ks3) and the public key KPp3 of the reproducing device 300. The encrypted session key E(KPd2, Ks3) thus acquired is transmitted to the fifth decryption unit 231. On the other hand, the public key KPp3 thus acquired is transmitted to the fourth encryption unit 232 and the log storage unit 234.

The fifth decryption unit 231 decrypts the data which has been encrypted using the public key KPp2 of the storage device 200. Specifically, the fifth decryption unit 231 decrypts the encrypted session key E(KPd2, Ks3) using the private key Kd2 of the storage device 200, thereby acquiring the session key Ks3. The session key Ks3 thus acquired is transmitted to the fifth encryption unit 233.

The fourth encryption unit 232 encrypts the data using the public key KPp3 of the reproducing device 300. Specifically, in a case of supplying the license data to the reproducing device 300, the fourth encryption unit 232 encrypts the license data LIC using the public key KPp3 received from the reproduction device 300. The license data LIC is read out from the tamper-resistant storage unit 204, and is transmitted to the fourth encryption unit 232 through the data bus 210, the control unit 220, and the local bus 240, according to instructions from the controller 201. The encrypted license data E(KPp3, LIC) thus encrypted is transmitted to the fifth encryption unit 233.

The fifth encryption unit 233 encrypts the data using the session key Ks3 issued by the reproducing device 300. Specifically, the fifth encryption unit 233 further encrypts the encrypted license data E(KPp3, LIC), which has been encrypted by the fourth encryption unit 232, using the session key Ks3, thereby creating encrypted license data E(Ks3, E(KPp3, LIC)).

The log storage unit 234 stores history information regarding communication and depletion of the license data LIC. The history information includes information LicID for specifying the license data LIC, the session key Ks3 which has been created in communication of the license data LIC and which is information for specifying communication of the license data LIC, and the information ST2 for representing the state in a range from communication of the license data up to the consumption thereof (reproduction).

The information ST2 comprises the public key KPp3 used only for the license transmission, and information indicating one of the states of: the state where the session key has been received (which will be refereed to as “state SP” hereafter); the state where the license data LIC has been transmitted for the purpose of reproduction (which will be referred to as “state SL” hereafter); the state where following output of the license data LIC for the purpose of reproduction, the stored license data LIC is restored to the previous state where the license data has not yet been transmitted (which will be referred to as “state SR” hereafter).

The sixth encryption unit 235 encrypts data using the public key KPp3 stored in the log storage unit 234. Specifically, let us say that the sixth encryption unit 235 receives the status information LicID//ST3//H(Kr2//Ks3//LicID//ST3). In this case, the sixth encryption unit 235 encrypts the recovery key Kr2 issued by the random number generating unit 221 using the public key KPd3 which has been received from the reproducing device 300 and is stored in the log storage unit 234, thereby creating recovery information E(KPp3, Kr2).

The log verification unit 236 verifies the validity of the status information LicID//ST3//H(Kr2//Ks3//LicID//ST3) received from the reproducing device 300 while referring to the history information stored in the log storage unit 234, thereby determining whether or not the license data should be restored.

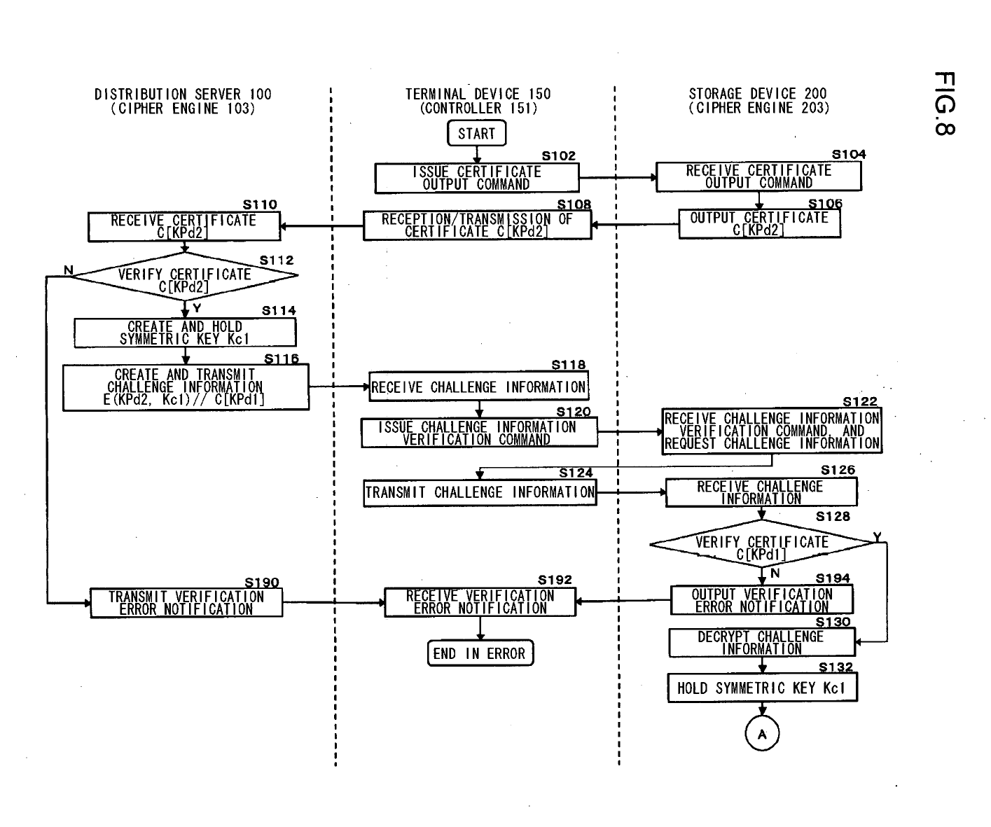

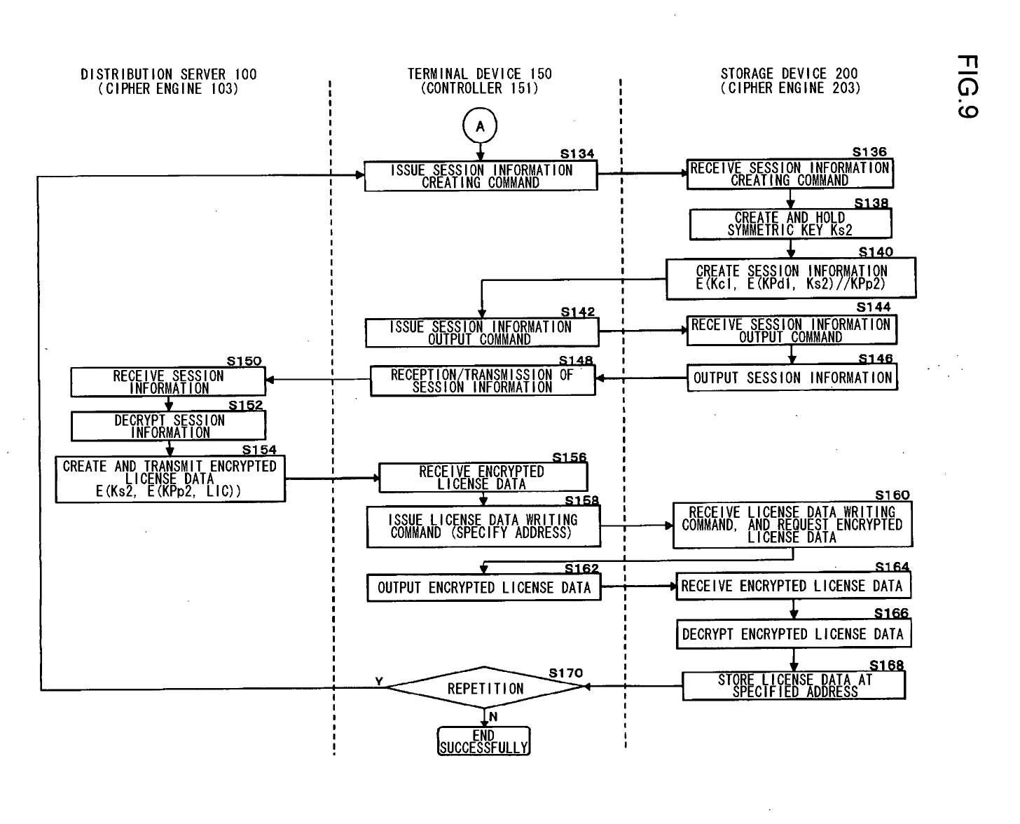

FIGS. 8 and 9 show a procedure up to the step where the distribution server 100 stores the license data LIC in the storage device 200. In the storage processing, an encrypted communication path is established between the cipher engine 103 of the distribution server 100 and the cipher engine 203 of the storage device 200. The license data LIC is transmitted from the distribution server 100 to the storage device 200 through the encrypted communication path. In the drawings, the processing is classified into three processing groups of: the processing group performed by the distribution server 100 (cipher engine 103); the processing group performed by the storage device 200 (cipher engine 203); and the processing group performed by the terminal device 150 (controller 151) for controlling exchange of data between the distribution server 100 and the storage device 200.

First, the controller 151 of the terminal device 150 issues a certificate output command to the storage device 200 (S102). Upon successful reception of the certificate output command (S104), the controller 201 of the storage device 200 instructs the cipher engine 203 to output the certificate. Then, the controller 201 reads out the certificate C[KPd2] from the cipher engine 203, and outputs the certificate C[KPd2] to the controller 151 of the terminal device 150 (S106). Upon acquisition of the certificate C[KPd2] from the storage device 200, the controller 151 transmits the certificate C[KPd2] thus acquired, to the distribution server 100 (S108).

Upon reception of the certificate C[KPd2] issued by the storage device 200 (S110), the controller 101 of the distribution server 100 transmits the certificate C[KPd2] thus received, to the cipher engine 103. Then, the certificate verification unit 120 verifies the certificate using the verification key KPa (S112). In a case that the certificate has not been authenticated (in a case of “NO” in S112), the certificate verification unit 120 transmits an error notification to the controller 101. Upon reception of the error notification, the controller 101 transmits a verification-error notification to the terminal device 150 (S190). In a case that the controller 101 has received the verification-error notification (S192), the processing ends in error.

In a case that the certificate has been authenticated (in a case of “YES” in S112), the cipher engine 103 generates the challenge key Kc1 by actions of the random number generating unit 122, and transmits the challenge key Kc1 thus generated, to the first encryption unit 121 and the first decryption unit 123. The first decryption unit 123 holds the challenge key Kc1 therein (S114). On the other hand, the first encryption unit 121 encrypts the challenge key Kc1 using the public key KPd2 of the storage device 200 acquired from the certificate C[KPd2], thereby creating an encrypted challenge key E(KPd2, Kc1). Then, the cipher engine 103 links the encrypted challenge key E(KPd2, Kc1) and the certificate C[KPd1] of the distribution server 100 output from the certificate output unit 127, thereby creating challenge information E(KPd2, Kc1)//C[KPd1], and transmits the challenge information thus created, to the controller 101. The controller 101 transmits the challenge information E(KPd2, Kc1)//C[KPd1] thus created, to the terminal device 150 (S116).

Upon reception of the challenge information E(KPd2, Kc1)//C[KPd1] (S118), the controller 151 of the terminal device 150 issues a challenge information verification command to the storage device 200 (S120). Upon the controller 201 of the storage device 200 receiving the challenge information verification command, the storage device 200 requests the terminal device 150 to output the challenge information E(KPd2, Kc1)//C[KPd1] (S122). In response to the request, the controller 151 of the terminal device 150 outputs the challenge information E(KPd2, Kc1)//C[KPd1] to the storage device 200 (S124).

Upon the storage device 200 receiving the challenge information E(KPd2, Kc1)//C[KPd1] (S126), the control unit 220 of the cipher engine 203 acquires the certificate C[KPd1] from the challenge information E(KPd2, Kc1)//C[KPd1], and transmits the certificate C[KPd1] thus acquired, to the certificate verification unit 223. The certificate verification unit 223 verifies the received certificate C[KPd1] using the verification key KPa, and transmits the verification results to the control unit 220 (S128).

In a case that the certificate has not been authenticated (in a case of “NO” in S128), the certificate verification unit 223 transmits a verification-error notification to the control unit 220. Then, the control unit 220 notifies the controller 201 of the verification-error notification. Subsequently, the controller 201 transmits the verification-error notification thus received, to the controller 151 of the terminal device 150 through the storage interface 202 (S194). In a case that the controller 101 has received the verification-error notification (S192), the processing ends in error.

In a case that the certificate has been authenticated (in a case of “YES” in S128), the control unit 220 acquires the public key KPd1 and the encrypted challenge key E(KPd2, Kc1) from the challenge information E(KPd2, Kc1)//C[KPd1]. The public key KPd1 and the encrypted challenge key E(KPd2, Kc1) thus acquired are transmitted to the first encryption unit 225 and the first decryption unit 224, respectively.

The first encryption unit 225 holds the public key KPd1 thus received. On the other hand, the first decryption unit 224 decrypts the encrypted challenge key E(KPd2, Kc1) thus received, using the private key Kd2 of the storage device 200, thereby acquiring the challenge key Kc1 (S130). Then, the challenge key Kc1 thus acquired is transmitted to and held by the second encryption unit 226 (S132).

On the other hand, upon completion of the processing instructed by the challenge information verification command in the storage device 200, the controller 151 of the terminal device 151 issues a session information creating command to the storage device 200 (S134). Upon the controller 201 of the storage device 200 receiving the session information creating command (S136), the random number generating unit 221 generates the session key Ks2 according to instructions from the control unit 220 in the cipher engine 203. The session key Ks2 thus generated is transmitted to the second decryption unit 227 and the first encryption unit 225. Note that the second decryption unit 227 holds the session key Ks2 thus received (S138).

The first encryption unit 225 encrypts the session key Ks2 thus received, using the public key KPd1 held in S130, thereby creating an encrypted session key E(KPd1, Ks2). The encrypted session key E(KPd1, Ks2) thus created is transmitted to the second encryption unit 226. The second encryption unit 226 links the encrypted session key E(KPd1, Ks2) and the public key KPp2 of the storage device 200, and encrypts the linked key data using the challenge key Kc1 held in Step S132. Thus, the second encryption unit 226 creates session information E(Kc1, E(KPd1, Ks2)//KPp2) (S140).

Upon completion of the processing instructed by the session information creating command in the storage device 200, the controller 151 of the terminal device 150 issues a session information output command (S142). Upon the storage device 200 receiving the session information output command (S144), the controller 201 reads out the session information E(Kc1, E(KPd1, Ks2)//KPp2) from the cipher engine 203, and outputs the session information thus read out, to the controller 151 of the terminal device 150 (S146). Upon reception of the session information E(Kc1, E(KPd1, Ks2)//KPp2) from the storage device 200, the controller 151 of the terminal device 150 transmits the session information thus received, to the distribution server 100 (S148).

Upon reception of the session information E(Kc1, E(KPd1, Ks2)//KPp2) (S150), the controller 101 of the distribution server 100 transmits the session information thus received, to the cipher engine 103. The first decryption unit 123 of the cipher engine 103 decrypts the session information E(Kc1, E(KPd1, Ks2)//KPp2) thus received, using the challenge key Kc1 stored therein, thereby acquiring the encrypted session key E(KPd1, Ks2) and the public key KPp2 of the storage device 200. The encrypted session key E(KPd1, Ks2) thus acquired is transmitted to the second decryption unit 124. Then, the second decryption unit 124 decrypts the encrypted session key E(KPd1, Ks2) using the private key Kd1 thereof, thereby acquiring the session key Ks2 (S152).

Subsequently, the second encryption unit 125 of the cipher engine 103 encrypts the license data LIC issued by the encryption device 102 using the public key KPp2 of the storage device 200, thereby creating encrypted license data E(KPp2, LIC). The encrypted license data E(KPp2, LIC) thus created is transmitted to the third encryption unit 126. Then, the third encryption unit 126 further encrypts the encrypted license data E(KPp2, LIC) thus received, using the session key Ks2 issued by the storage device 200, thereby creating the encrypted license data E(Ks2, E(KPp2, LIC)). The encrypted license data E(Ks2, E(KPp2, LIC)) thus created is transmitted to the controller 101. The controller 101 transmits the encrypted license data E(Ks2, E(KPp2, LIC)) thus received, to the terminal device 150 (S154).

Upon the controller 151 of the terminal device 150 receiving the encrypted license data E(Ks2, E(KPp2, LIC)) from the distribution server 100 (S156), the controller 151 issues a license data writing command to the storage device 200 (S158). The license writing command includes an address for specifying the recording location in the tamper-resistant storage unit 204. Note that the address as used here means “logical address”. While the logical address does not directly specify the recording location in the tamper-resistant storage unit 204, the controller 201 manages storage of data so as to allow readout of the data using the same logical address as in the writing processing. Also, the storage device 200 may employ the physical address for directly specifying the recording location in the tamper-resistant storage unit 204.

Upon the storage device 200 receiving the license writing command issued by the terminal device 150 (S160), the storage device 200 requests the controller 151 of the terminal device 150 to output the encrypted license data (S160). In response to the request, the controller 151 of the terminal device 150 outputs the encrypted license data E(Ks2, E(KPp2, LIC)) to the storage device 200 (S162). Upon reception of the encrypted license data E(Ks2, E(KPp2, LIC)) (S164), the storage device 200 transmits the encrypted license data thus received, to the second decryption unit 227 within the cipher engine 203. The second decryption unit 227 decrypts the encrypted license data E(Ks2, E(KPp2, LIC)) using the session key Ks2 stored therein, thereby acquiring the encrypted license data E(KPp2, LIC), which has been encrypted using the public key KPp2 of the storage device 200. Then, the encrypted license data E(KPp2, LIC) thus acquired is transmitted to the third decryption unit 228. The third decryption unit 228 decrypts the encrypted license data E(KPp2, LIC) thus received, using the private key Kp2 forming a pair along with the public key KPp2, thereby acquiring the license data LIC (S166). The license data LIC thus acquired is output to the data bus 210 through the local bus 240 and the control unit 220. The controller 201 stores the license data LIC thus output to the data bus 210, in the tamper-resistant storage unit 204 according to a specified address (S168).

Upon completion of the processing instructed by the license data writing command in the storage device 200, the controller 151 of the terminal device 150 determines whether or not recording of the license data is to be continued (S170). In a case of consecutively recording of the license data (in a case of “YES” in S170), the flow proceeds to Step S134, thereby restarting the processing starting from issuing of the session information creating command. With the present embodiment, the verification of the certificate is shared among multiple license-data recording procedures, thereby reducing the processing amount. While description has been made regarding an example in which multiple license data sets are consecutively recorded, with such a configuration, there is no need to record the next license data immediately following recording of a certain license data set. Rather, with such a configuration, the next data may be recording at a desired timing as long as the cipher engine 103 of the distribution server 100 and the cipher engine 203 of the storage device 200 share the same challenge key Kc1, and specifically, as long as the first decryption unit 123 of the cipher engine 103 of the distribution server 100 and the second encryption unit 226 of the cipher engine 203 of the storage device 200 hold the same challenge key Kc1. Also, an arrangement may be made without any problems, in which the next data is recorded following the procedure starting from Step S102 even if the license data is consecutively recorded. On the other hand, in a case that the license data is not consecutively recorded (in a case of “NO” in S170), the processing ends successfully.

With the procedure described above, the license data, which is necessary for decrypting and reproducing the encrypted contents, is stored in the storage device 200. On the other hand, the encrypted contents data is ordinary data. With the present embodiment, the encrypted contents data is stored according to ordinary commands, and accordingly, description thereof will be omitted.

Note that the recording order of the license data and the encrypted contents data is not restricted. Furthermore, an arrangement may be made in which the secure command is issued in a divided form using free time in which the storage device 200 is not storing the encrypted contents data, thereby recording the license data.

Note that FIGS. 8 and 9 show an example of the procedure in which the terminal device 150 stores the license data LIC, which has been received from the distribution server 100, in the storage device 200, and the processing ends successfully.

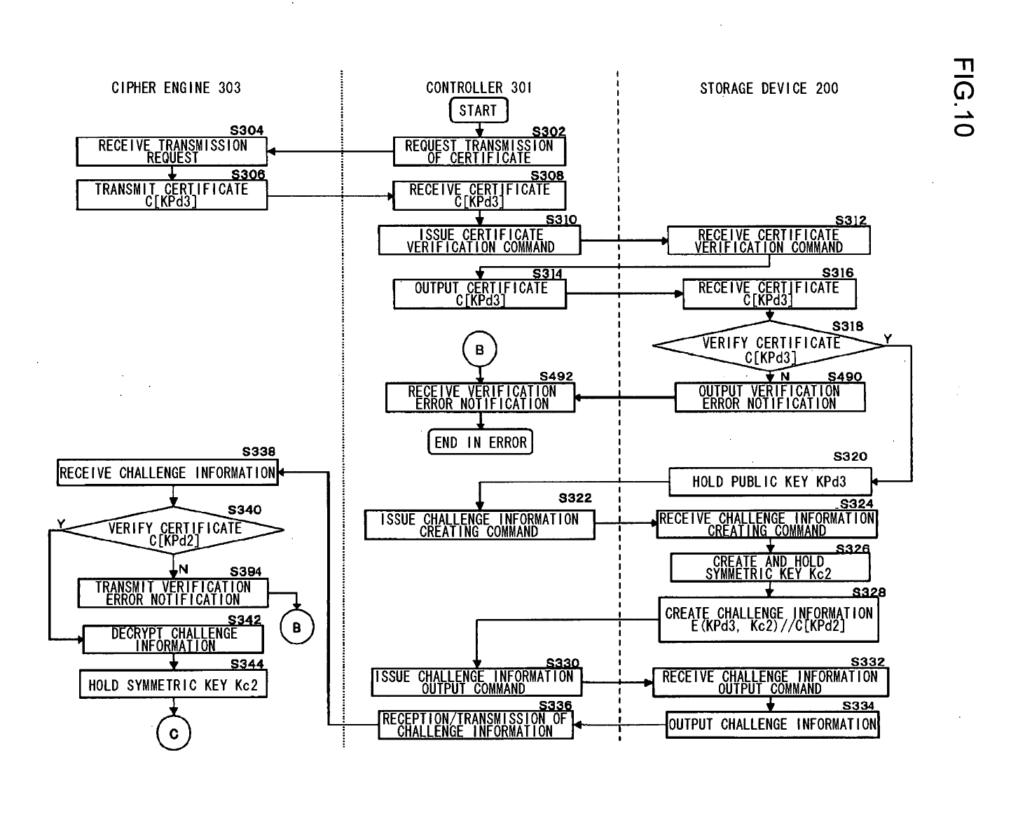

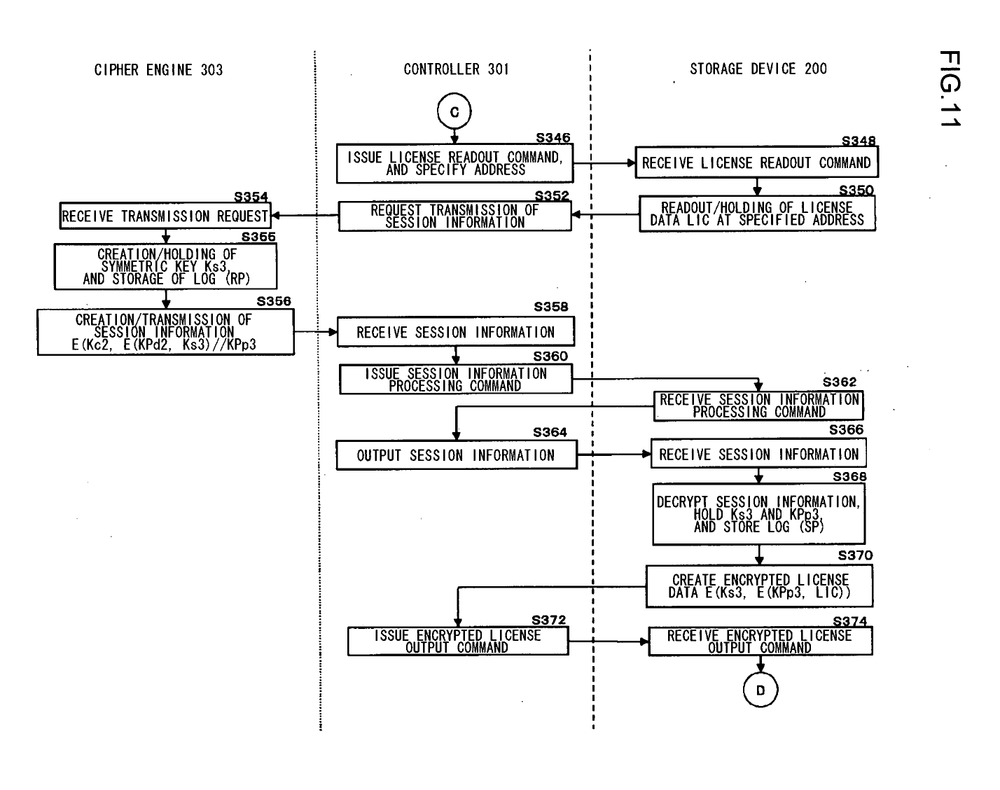

FIGS. 10 and 11 show a procedure for reproduction processing up to the step in which the reproducing device 300 reads out the license data LIC from the storage device 200, and discards the contents key thus read out. With the reproduction processing, an encrypted communication path is established between the cipher engine 203 of the storage device 200 and the cipher engine 303 of the reproducing device 300. The license data LIC is transmitted from the storage device 200 to the reproducing device 300 through the encrypted communication path thus established. In the drawings, the processing is classified into three processing groups of: the processing group performed by the storage device 200 (cipher engine 203); the processing group performed by the cipher engine 303 of the reproducing device 300; and the processing group performed by the controller 301 of the reproducing device 300 for controlling exchange of data between the storage device 200 and the cipher engine 303.

First, the controller 301 of the reproducing device 300 requests the cipher engine 303 to output the certificate (S302). Upon the cipher engine 303 receiving the transmission request (S304), the certificate output unit 320 transmits the certificate C[KPd3] to the controller 301 (S306). Upon the controller 301 receiving the certificate C[KPd3] from the cipher engine 303 (S308), the controller 301 issues the certificate verification command to the storage device 200 (S310).

Upon the storage device 200 receiving the certificate verification command (S312), the storage device 200 requests the reproducing device 300 to output the certificate. In response to the request, the controller 301 of the reproducing device 300 outputs the certificate C[KPd3] received from the cipher engine 303, to the storage device 200 (S314). Upon the storage device 200 receiving the certificate C[KPd3] (S316), the storage device 200 transmits the certificate C[KPd3] thus received, to the cipher engine 203 therewithin. In the cipher engine 203, the certificate verification unit 223 verifies the certificate C[KPd3] using the verification key KPa according to instructions from the control unit 220 (S318).

In a case that the certificate has not been authenticated in S318 (in a case of “NO” in S318), the certificate verification unit 223 transmits a verification error notification to the controller 301 through the control unit 220, the controller 201, and the storage interface 202 (S490). In a case that the controller 301 has received the error notification (S492), the processing ends in error.

On the other hand, in a case that the certificate C[KPd3] has been authenticated in S318 (in a case of “YES” in S318), the control unit 220 of the cipher engine 203 acquires the public key KPd3 from the certificate C[KPd3], and transmits the public key KPd3 thus acquired, to the third encryption unit 229. The third encryption unit 229 holds the public key KPd3 thus received (S320).

In a case that the certificate C[KPd3] of the cipher engine 303 is authenticated in the storage device 200, the controller 301 of the reproducing device 300 issues a challenge information creating command to the storage device 200 (S322). Upon the storage device 200 receiving the challenge information creating command issued by the reproducing device 300 (S324), in the cipher engine 203, the random number generating unit 221 generates the challenge key Kc2 according to instructions from the control unit 220, and transmits the challenge key Kc2 thus generated, to the third encryption unit 229 and the fourth decryption unit 230.

The fourth decryption unit 230 stores the received challenge key Kc2 therewithin (S326). The third encryption unit 229 encrypts the challenge key Kc2 thus received, using the public key KPd3 held in Step S320, thereby creating an encrypted challenge key E(KPd3, Kc2). Then, the storage device 200 receives the certificate C[KPd2] thereof from the certificate output unit 222, and links the encrypted challenge key E(KPd3, Kc2) thus created and the certificate C[KPd2] thus received, thereby creating challenge information E(KPd3, Kc2)//C[KPd2] (S328).

Upon completion of the processing instructed by the challenge information creating command in the storage device 200, the controller 301 of the reproducing device 300 issues a challenge information output command (S330). Upon the storage device 200 receiving the challenge information output command (S332), the controller 201 acquires the challenge information E(KPd3, Kc2)//C[KPd2] from the cipher engine 203, and outputs the challenge information to the controller 301 of the reproducing device 300 (S334).

In the reproducing device 300, upon the controller 301 receiving the challenge information E(KPd3, Kc2)//C[KPd2], the controller 301 transmits the challenge information thus received, to the cipher engine 303 (S336). Then, upon the cipher engine 303 receiving the challenge information E(KPd3, Kc2)//C[KPd2] (S338), the certificate verification unit 322 included within the cipher engine 303 verifies the certificate using the verification key KPa (S340).

In a case that the certificate has not been authenticated (in a case of “NO” in S340), the certificate verification unit 322 transmits a verification error notification to the controller 301 (S394). In a case that the controller 301 has received the error notification (S492), the processing ends in error.

On the other hand, in a case that the certificate has been authenticated (in a case of “YES” in S340), the first decryption unit 323 of the cipher engine 303 decrypts the encrypted challenge key E(KPd3, Kc2) using the private key Kd3 of the reproducing device 300, thereby acquiring the challenge key Kc2 (S342). The challenge key Kc2 thus acquired is transmitted to and held by the second encryption unit 325 (S344).

On the other hand, the controller 301 issues a license readout command to the storage device 200 (S346). The license readout command includes an address for specifying the readout location in the tamper-resistant storage unit 204.

Upon the storage device 200 receiving the license readout command issued by the reproducing device 300 (S348), the storage device 200 reads out the license data LIC stored at the specified address in the tamper-resistant storage unit 204. The license data LIC thus read out is held by the fourth encryption unit 232 of the cipher engine 203 (S350).

Subsequently, the controller 301 requests the cipher engine 303 to output the session information (S352). Upon the cipher engine 303 receiving the request (S354), the random number generating unit 321 generates the session key Ks3, and transmits the session key Ks3 thus generated, to the first encryption unit 324, the second decryption unit 326, and the log storage unit 330. The second decryption unit 326 and the log storage unit 330 hold the received session key Ks3 therewithin. At this time, the log storage unit 330 also holds information regarding the “state RP” in the form of the information ST3 (S355). On the other hand, the first encryption unit 324 encrypts the session key Ks3, using the public key KPd2 of the storage device 200 acquired from the certificate C[KPd2], thereby creating an encrypted session key E(KPd2, Ks3). The encrypted session key E(KPd2, Ks3) thus created is transmitted to the second encryption unit 325. The second encryption unit 325 links the encrypted session key E(KPd2, Ks3) thus received and the public key KPp3 of the reproducing device 300, and encrypts the linked key data using the challenge key Kc2 held in Step S344, thereby creating session information E(Kc2, E(KPd2, Ks3)//KPp3). The session information thus created is transmitted to the controller 301 (S356).

Upon the controller 301 receiving the session information E(Kc2, E(KPd2, Ks3)//KPp3) from the cipher engine 303 (S358), the controller 301 issues a session information processing command to the storage device 200 (S360).

Upon the storage device 200 receiving the session information processing command issued by the reproducing device 300 (S362), the storage device 200 requests the reproducing device 300 to output the session information. In response to the request, the controller 301 of the reproducing device 300 outputs the session information E(Kc2, E(KPd2, Ks3)//KPp3) received from the cipher engine 303, to the storage device 200 (S364).

Upon the storage device 200 receiving the session information E(Kc2, E(KPd2, Ks3)//KPp3) (S366), the storage device 200 transmits the session information thus-received, to the fourth decryption unit 230 of the cipher engine 203. The fourth decryption unit 230 decrypts the session information E(Kc2, E(KPd2, Ks3)//KPp3) thus received, using the challenge key Kc2 held in Step S326. Thus, the fourth decryption unit 230 acquires the encrypted session key E(KPd2, Ks3) and the public key KPp3 of the reproducing device 300. Then, the fourth decryption unit 230 transmits the encrypted session key E(KPd2, Ks3) to the fifth decryption unit 231, as well as transmitting the public key KPp3 to the fourth encryption unit 232 and the log storage unit 234.

Subsequently, the fifth decryption unit 231 decrypts the encrypted session key E(KPd2, Ks3) thus received, using the private key Kd2 forming a pair along with the public key KPd2 of the storage device 200, thereby acquiring the session key Ks3. The session key Ks3 thus acquired is transmitted to the fifth encryption unit 233 and the log storage unit 234. The log storage unit 234 holds the session key Ks3 and the public key KPp3 thus received. Furthermore, the log storage unit 234 also holds information indicating the “state SP” (S368).

The fourth encryption unit 232 encrypts the license data LIC held in S350 using the public key KPp3 of the reproducing device 300 thus received from the fourth decryption unit 230, thereby creating encrypted license data E(KPp3, LIC). The encrypted license data thus created is transmitted to the fifth encryption unit 233. The fifth encryption unit 233 encrypts the encrypted license data E(KPp3, LIC), which has been created by the fourth encryption unit 232, using the session key Ks3 received from the fifth decryption unit 231, thereby creating the encrypted license data E(Ks3, E(KPp3, LIC)) (S370).

Upon completion of the processing instructed by the session information processing command in the storage device 200, i.e., upon creation of the encrypted license data E(Ks3, E(KPp3, LIC)), the controller 301 of the reproducing device 300 issues an encrypted-license output command to the storage device 200 (S372). Upon the storage device 200 receiving the encrypted-license output command issued by the reproducing device 300 (S374), the control unit 220 of the cipher engine 203 checks the control information PC described in the license data LIC (S376).

In a case of the control information PC of 0 (in a case of “IV” in S376), the control unit 220 determines that the license data has reproduction-times restriction, and the reproduction has already been performed a predetermined limited number of times. Accordingly, the control unit 220 transmits a reproduction-condition error notification to the controller 301 of the reproducing device 300 through the controller 201 and the storage interface 202 (S460). Upon the controller 301 of the reproducing device 300 receiving the error notification transmitted from the storage device 200 (S462), the processing ends in error.

On the other hand, in a case of the control information PC of 1 through 254 in S376 (in a case of “C” in S376), the control unit 220 decrements the control information PC included in the license data stored in the tamper-resistant storage unit 204 by 1 (S378).

On the other hand, in a case of the control information PC of 255 in S376 (in a case of “NA” in S376), or following S378, the control unit 220 outputs the encrypted license data E(Ks3, E(KPp3, LIC)) to the controller 301 of the reproducing device 300 through the controller 201 and the storage interface 202. In this case, furthermore, the control unit 220 instructs the log storage unit 234 to hold the identifying information LicID of the license data LIC thus output, as well as updating the information ST2 to the “state SL” (S380).

Upon reception of the encrypted license data E(Ks3, E(KPp3, LIC)) from the storage device 200, the controller 301 of the reproducing device 300 transmits the encrypted license data thus received, to the cipher engine 303 (S382). Then, upon the cipher engine 303 receiving the encrypted license data E(Ks3, E(KPp3, LIC)) (S384), the second decryption unit 326 decrypts the encrypted license data E(Ks3, E(KPp3, LIC)) using the session key Ks3 held in Step S354, and transmits the decryption result E(KPp3, LIC) to the third decryption unit 327.

The third decryption unit 327 decrypts the decryption result E(KPp3, LIC) thus received, using the private key Kp3 forming a pair along with the public key KPp3 of the reproducing device 300, thereby acquiring the license data LIC. Furthermore, the third decryption unit 327 transmits the identifying information LicID regarding the license data LIC to the log storage unit 330, as well as transmitting the contents key to the contents key output unit 328.

The log storage unit 330 holds the identifying information LicID thus received, and updates the information ST3 to the “state RL” (S386). The contents key output unit 328 starts to provide the contents key thus received, to the decryption unit 304 (S388).

In a case that the contents key has become available to the decryption device 304, the controller 301 confirms whether or not reproduction should end. That is to say, the controller 301 confirms whether or not reproduction of the encrypted contents data has been completed, and whether or not the user gives reproduction-cancel instruction (including instructions such as termination operation, reproduction stop by selection operation, and so forth), thereby determining whether or not reproduction should end.

In a case that determination has been made that reproduction should not end in S390 (in a case of “NO” in S390), the controller 301 reads out the encrypted contents data stored in the ordinary data storage unit 205 of the storage device 200, and transmits the encrypted contents data thus read out, to the decryption device 304 (S392). In this case, the controller 301 intermittently transmits the encrypted contents data to the decryption unit 304 in increments of necessary data amount so as to allow the contents decoder 305 to make smooth reproduction. Then, the flow returns to S390 again where the controller 301 determines whether or not the reproduction should end, using free time in which the control unit is not transmitting the encrypted contents data to the decryption device 304.

On the other hand, with the cipher engine 303, in a case that the contents key has become available to the decryption device 304, the contents key output unit 328 starts monitoring processing for monitoring decryption processing performed by the decryption device 304, in parallel with the processing performed by the controller 301 (S400). Specifically, the contents key output unit 328 confirms whether or not reproduction has been started using the contents key thus provided, and whether or not reproduction has been canceled before using the contents key (S402).

In a case that confirmation has been made in S402 that reproduction has been started (in a case of “YES” in S402), the elapsed-time measurement unit 329 resets the timer. Then, the elapsed-time measurement unit 329 starts measurement of the duration of the reproduction processing, and waits time of T seconds (S404). After duration of T seconds (in a case of “YES” in S402), the elapsed-time measurement unit 329 notifies the log storage unit 330 that the license data LIC has been used up. Upon reception of the information, the log storage unit 330 updates the information ST3 stored therein, to the “state CL” (S406), whereby the monitoring processing performed by the cipher engine 303 ends.

Furthermore, in a case that confirmation has been made that reproduction has ended in S402 or S404 (in a case of “S” in S402 or S404), the monitoring processing performed by the cipher engine 303 ends. In this case, the information ST3 stored in the log storage unit 330 remains “state RL”.

In a case that the controller 301 has confirmed that reproduction has ended in S390 (in a case of “YES” in S390), confirmation is made whether or not reproducing time exceeds the predetermined time of T seconds (S394). With such an arrangement, the confirmation may be made using a timer included in the controller 301. Also, the confirmation may be made with reference to the elapsed-time measurement unit 329 of the cipher engine 303. Also, the confirmation may be made based upon the state of the information ST3 stored in the log storage unit 330 of the cipher engine 303.

In a case that reproduction has been made for the duration of T seconds in S394 (in a case of “YES” in S394), the controller 301 determines that the license data has been used up, and determines whether or not the next contents are consecutively reproduced (S396). In a case that the reproduction is not consecutively performed, i.e., in a case that no other license data is read out (in a case of “NO” in S396), the processing ends successfully.

In a case that reproduction is consecutively made, i.e., in a case of reading out the next license data in S396 (in a case of “YES” in S396), the controller 301 may operate as follows. That is to say, the flow proceeds to Step S346, thereby restarting the procedure starting from the step where the license readout command is issued. With the present embodiment, the verification of the certificate is shared among multiple license-data readout procedures, thereby reducing the processing amount. While description has been made regarding an example in which multiple license data sets are consecutively read out, with such a configuration, there is no need to read out the next license data immediately following readout of certain license data. Rather, with such a configuration, the next license data may be read out at a desired timing as long as the cipher engine 303 and the storage device 200 share the challenge key Kc2, and specifically, as long as the second encryption unit 325 of the cipher engine 303 of the reproducing device 300 and the fourth decryption unit 230 of the cipher engine 203 of the storage device 200 hold the same challenge key Kc2. Also, an arrangement may be made without any problems, in which the next license data is read out following the procedure starting from Step S302 even if the license data is consecutively read out. In a case that the license data is not consecutively read out (in a case of “NO” in S386), the processing ends successfully according to instructions from the controller 301.

On the other hand, in a case that reproduction has been made for a duration less than the predetermined time of T seconds, or in a case that reproduction has not been made (in a case of “NO” in S394), the controller 301 determines that the license data has not been used up, and starts restoration processing for the license data LIC stored in the storage device 200.

The controller 301 of the reproducing device 300 issues a recovery information creating command to the storage device 200 (S410). Upon the storage device 200 receiving the recovery information creating command issued by the reproducing device 300 (S412), in the cipher engine 203, the random number generating unit 221 generates the recovery key Kr2 according to instructions from the control unit 220. The recovery key Kr2 thus generated is transmitted to the sixth encryption unit 235 and the log verification unit 236. The log verification unit 236 holds the recovery key Kr2 thus received, therewithin (S414). The sixth encryption unit 235 encrypts the recovery key Kr2 thus received, using the public key KPp3 held by the log storage unit 234, thereby creating recovery information E(KPp3, Kr2) (S416).

On the other hand, upon completion of the processing instructed by the recovery information creating command in the storage device 200, the controller 301 of the reproducing device 300 issues a recovery information output command (S418). Upon the storage device 200 receiving the recovery information output command issued by the reproducing device 300 (S420), the controller 201 acquires the recovery information E(KPp3, Kr2) from the cipher engine 203, and outputs the recovery information thus acquired, to the controller 301 of the reproducing device 300 (S422). Upon the controller 301 of the reproducing device 300 receiving the recovery information E(KPp3, Kr2) output from the storage device 200, the controller 301 transmits the recovery information thus received, to the cipher engine 303 (S424).

Upon the cipher engine 303 receiving the recovery information E(KPp3, Kr2) (S426), the fourth decryption unit 331 of the cipher engine 303 decrypts the recovery information E(KPp3, Kr2) using the private key Kp3 of the reproducing device 300, thereby acquiring the recovery key Kr2 (S428). The recovery key Kr2 thus acquired is transmitted to the log signature unit 332. Furthermore, the log signature unit 332 acquires the session key Ks3, the identifying information LicID, and the information ST3, from the log storage unit 330. Then, the log signature unit 332 links these data sets and the recovery key Kr2 thus received from the fourth decryption unit 331, thereby creating data Kr2//Ks3//LicID//ST3. Then, hash computation is performed, thereby computing H(Kr2//Ks3//LicID//ST3). Furthermore, the computation result is linked with the identifying information LicID and the state information ST3, thereby creating the status information LicID//ST3//H(Kr2//Ks3//LicID//ST3). The status information thus created is output to the controller 301 of the reproducing device 300 (S430).

Upon the controller 301 of the reproducing device 300 receiving the status information LicID//ST3//H(Kr2//Ks3//LicID//ST3) from the cipher engine 303 (S432), the controller 301 issues a status information processing command to the storage device 200 (S434). Upon the storage device 200 receiving the status information processing command issued by the reproducing device 300 (S436), the storage device 200 requests the reproducing device 300 to output the status information. In response to the request, the controller 301 of the reproducing device 300 outputs the status information LicID//ST3//H(Kr2//Ks3//LicID//ST3) received from the cipher engine 303, to the storage device 200 (S438).

Upon the storage device 200 receiving the status information LicID//ST3//H(Kr2//Ks3//LicID//ST3) (S340), the storage device 200 transmits the status information thus received, to the cipher engine 203 included therewithin. In the cipher engine 203, the log verification unit 236 verifies the status information thus received, according to instructions from the control unit 220. Then, determination is made whether or not the license data should be restored, i.e., whether or not the license data should be returned to the state where the license data has not been output, based upon the verification results indicating whether or not the status information is valid (S442).

The status information is verified in S442 by making two confirmations as follows.

1) Confirmation whether or not the identifying information LicID included in the status information and the identifying information LicId stored in the log storage unit 234 match one another.

2) Confirmation whether or not the hash-function computation result H(Kr2//Ks3//LicID//ST3) and the hash value H(Kr2//Ks3//LicID//ST3) match one another. Here, the hash-function computation result H(Kr2//Ks3//LicID//ST3) is obtained as follows. That is to say, the identifying information LicID and the state information ST3 stored in the status information, the session key Ks3 held by the log storage unit 234, and the recovery key Kr2 held in Step S414 are linked with each other, and the hash-function computation is performed for the linked data sequence, thereby creating the hash-function computation result H(Kr2//Ks3//LicID//ST3).

In a case of conditions not being satisfied in either one of the aforementioned two confirmations, determination is made that the status information is not valid. In this case, determination is made that the license data should not be restored (the case of “NO” in S442). Furthermore, the control unit 220 transmits the recovery-error notification to the controller 301 of the reproducing device 300 through the controller 201 and the storage interface 202 (S450). In a case that the controller 301 of the reproducing device 300 has received the error notification output from the storage device 200 (S452), the flow proceeds to S396, and the processing is continued.

On the other hand, in a case that conditions are satisfied in both the aforementioned two confirmations, determination is made that that the status information is valid, and accordingly, the status information is authenticated. Furthermore, determination is made whether or not the license data is to be restored, based upon the information ST3 and the information ST2 stored in the log storage unit 234. This is due to the fact that the license data which is to be restored is restricted to that which has been output from the storage device 200 and which has not been used up by the reproducing device 300. Specifically, the license data which is to be restored is restricted to that with the information ST2 of “state SL” and the information ST3 of “state RP” or “State RL”.

In a case that determination has been made that the license data is to be restored in the aforementioned determination processing (in a case of “YES” in S442), and in a case that the control information PC of the license data stored in the tamper-resistant storage unit 204 does not match a special number of 255, the control information PC is incremented by 1 (S444). Then, the control unit 220 transmits a recovery notification to the controller 301 of the reproducing device 300 through the controller 201 and the storage interface 202 (S446). Upon the controller 301 of the reproducing device 300 receiving the error notification output from the storage device 200 (S448), the flow proceeds to S398, and the processing is continued.

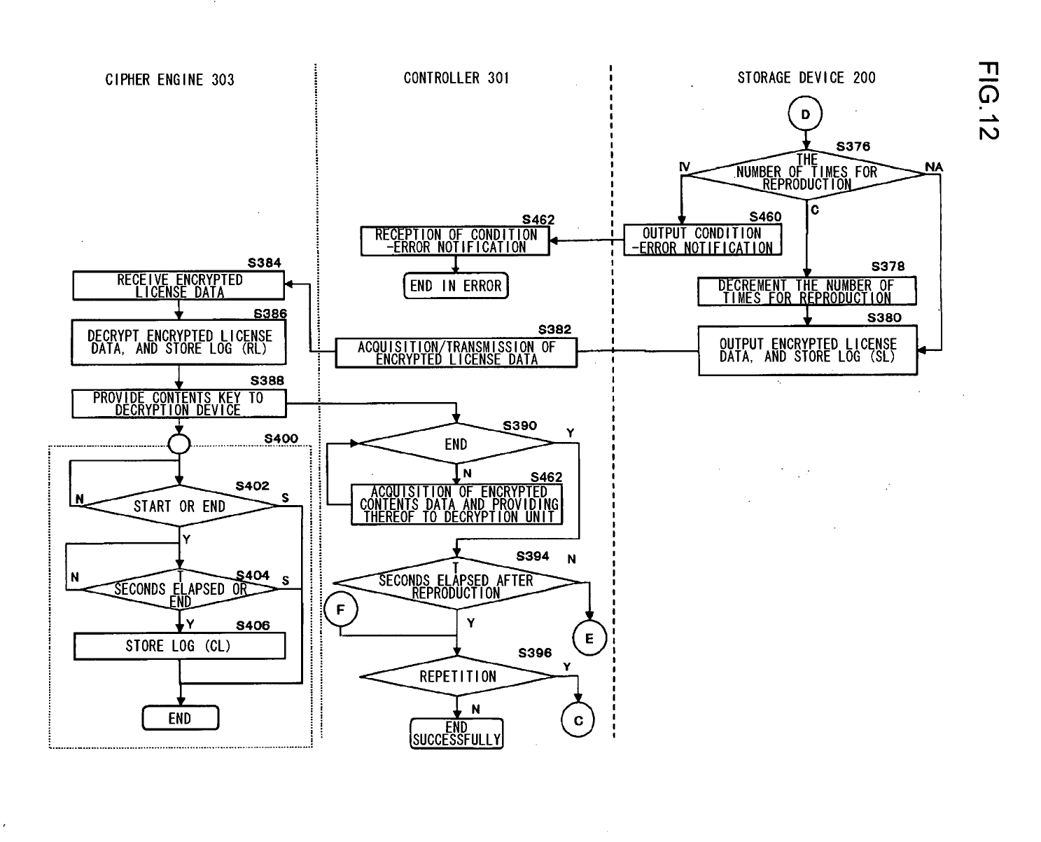

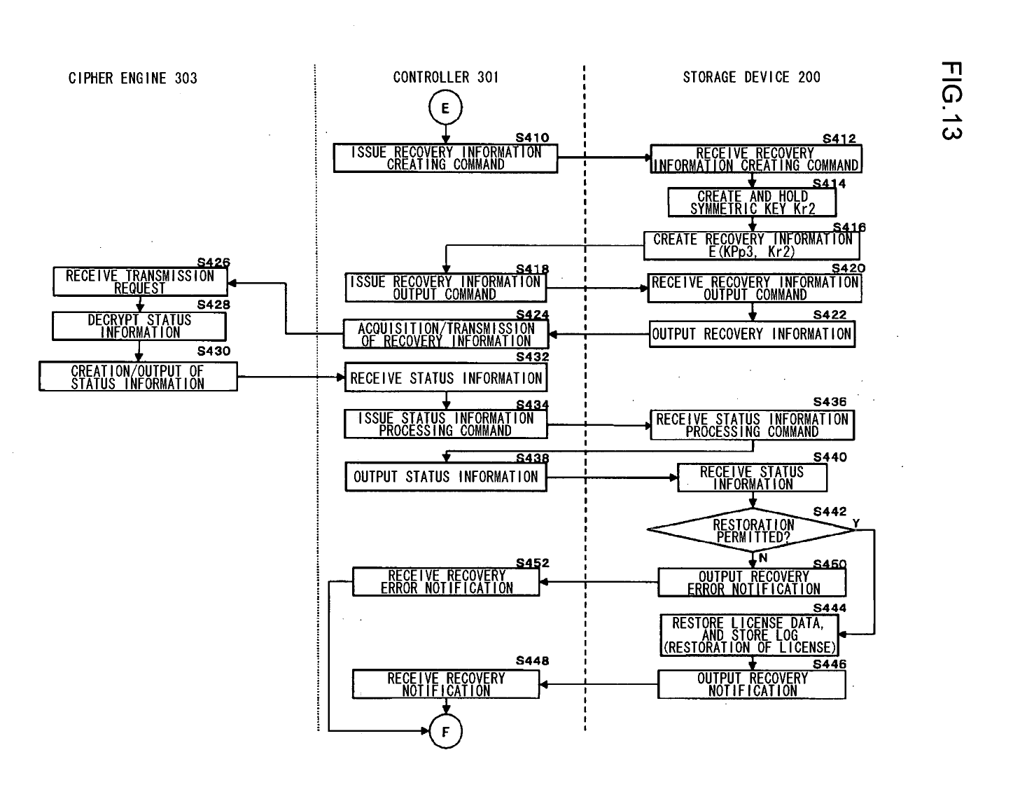

Note that FIGS. 10 through 13 show an example of the procedure in which the reproducing device 300 uses the license data stored in the storage device 200, and the processing ends successfully.

Note that description has been made in the present embodiment regarding an arrangement in which the device measures the duration of the decryption processing performed by the decryption device 304, thereby measuring the reproduction duration used for determination whether or not the license data has been used up. Also, an arrangement may be made in which the device measures the duration over which the decryption device 304 provides the decryption results to the contents decoder 305. Also, an arrangement may be made in which the device measures the duration of the decoding processing in the contents decoder 305. Also, an arrangement may be made in which the device measures the duration over which the contents data 305 provides a reproduction signal.

Description has been made in the present embodiment regarding an arrangement in which the time threshold T, which is used for determining whether or not the license data has been used up, is determined beforehand for each kind of contents, e.g., the music contents, the video contents, and so forth. Also, an arrangement may be made in which the license data LIC includes the time threshold T as a user agreement. Also, a combination of these arrangements may be made. For example, with such a combination, in a case that the time threshold T has not been determined as a user agreement, the time threshold determined beforehand is used.

Description has been made in the present embodiment regarding an arrangement in which the elapsed-time measurement unit 329 measures the reproduction duration using a timer included therewithin, and in a case that reproduction has been made for the duration of the time threshold of T seconds, determination is made that the license data has been used up. Also, an arrangement may be made in which the duration for which reproduction has been made is calculated based upon the processed data amount (encrypted or decrypted data amount), and determination is made whether or not the license data has been used up based upon the calculation results. That is due to the fact that the reproduction duration can be calculated based upon the processed data amount of the contents data due to the nature of the coding format used for encoding of the contents data. Also, an arrangement may be made handling the video contents, in which the reproduction duration is calculated based upon the number of frames of decrypted or reproduced video data. Also, an arrangement may be made in which the reproduction duration is calculated by referring to the time stamp in the stream data, e.g., “time_code” embedded in TS of MPEG data.

Description has been made regarding an arrangement in which determination is made whether or not the license data has been used up, based upon the reproduction duration. Also, an arrangement may be made in which determination is made whether or not the license data has been used up, by making a comparison between the reproduced data amount which has been measured and a data-amount threshold which has been set beforehand. Also, an arrangement may be made in which the device calculates the data amount for which determination is made that the license data is not used up, and provides the data of the calculated amount to the contents decoder 305. With such an arrangement, upon completion of reproduction of the contents data of the calculated amount for which determination is made that the license data is not used up, the device may inquire of the user whether or not the reproduction is to be continued. In a case that the user gives an instruction to cancel the reproduction, the license data is restored according to the license-data restoration procedure as described above. On the other hand, in a case that the user gives an instruction to continue the reproduction, the reproduction is continued, and the license data is not restored.

Description has been made in the present embodiment regarding an arrangement in which the challenge key Kc2 and the recovery key Kr2 are handled as separate keys. With such an arrangement, both the challenge key Kc2 and the recovery key Kr2 are the shared keys generated by the random number generating unit 221 of the storage device 200 serving as a receiver of the license data. Accordingly, giving consideration to the aforementioned fact, an arrangement may be made in which the recovery key Kr2 is generated instead of updating the challenge key Kc2. With such an arrangement, in the cipher engine 203 of the storage device 200, the recovery key Kr2 generated by the random number generating unit 221 is also transmitted to the fourth decryption unit 230, and the fourth decryption unit 230 holds the recovery key Kr2 thus received, instead of the challenge key Kc2 held up to this point. With such an arrangement, in the repetition processing from S346, the session information is decrypted using the recovery key Kr2 thus held instead of the challenge key Kc2. With the cipher engine 303 of the reproducing device 300, the recovery key Kr2 acquired by the fourth decryption unit 331 is transmitted to the second encryption unit 325, and the second encryption unit 325 holds the recovery key Kr2 thus received, instead of the challenge key Kc2 held up to this point. With such an arrangement, in the repetition processing from S346, the session information is created using the recovery key Kr2 instead of the challenge key Kc2.

Description has been made regarding a license-data restoration procedure in which the control unit 220 of the storage device 200 increments the control information PC of the license data stored in the tamper-resistant storage unit 204 by 1, thereby restoring the license data. Also, an arrangement may be made in which upon output of the license data from the storage device 200, the control information PC of the license data in the state where the license data has not been output is stored in the log storage unit 234. With such an arrangement, in a case of receiving a request to restore the license data, the control information PC of the license data stored in the tamper-resistant storage unit 204 is overwritten with the control information PC stored in the log storage unit 234 in the state where the license data has not been output, thereby restoring the control information PC to the previous state. This returns the control information PC of the license data to the previous state in a sure manner.

Furthermore, an arrangement may be made in which the control information PC in the state where the license data has not been output is stored in the log storage unit 330 of the reproducing device 300. With such an arrangement, in a case of the reproducing device 300 making a request to restore the license data, the control information PC in the state where the license data has not been output is read out from the log storage unit 330, and is transmitted to the storage device 200. Then, the control information PC of the license data stored in the tamper-resistant storage unit 204 is overwritten with the control information thus transmitted. With such an arrangement, the reproducing device 300 may transmits the control information PC and the identifying information LicID in a form encrypted using a shared key shared with the storage device 200, e.g., the session key Ks2 or the like. The control unit 220 of the storage device 200 decrypts the encrypted control information PC received from the reproducing device 300, and overwrites the control information PC of the license data stored in the tamper-resistant storage unit 204 with the control information PC thus decrypted.

Description has been made regarding an encrypted-communication path establishment procedure in which a one-way encrypted communication path is established between the license-data provider and receiver. Also, an arrangement may be made in which a two-way encrypted communication path is established. With such an arrangement, a communication protocol may be employed in which the storage device 200 operates serving as a client device regardless of the direction in which the license data is transmitted. For example, a two-way encrypted communication path may be established between the reproducing device 300 and the storage device 200, in which the reproducing device 300 which is a license-data receiver operates serving as a host device, and the storage device 200 which is a license-data provider operates serving as a client device. This enables design of the configuration of the storage device 200 in a simple manner. With such a communication mode, let us say that the reproducing device 300 requests the storage device 200 to restore the license data. In this case, an arrangement may be made in which the reproducing device 300 instructs the storage device 200 to output the status information, and determines whether or not the license data should be restored. Furthermore, an arrangement may be made in which in a case that determination has been made that the license data should be restored, the reproducing device 300 transmits the control information PC of the license data in the previous state to the storage device 200, and overwrites the control information PC of the license data stored in the tamper-resistant storage unit 204 with the control information PC in the previous state thus transmitted, thereby restoring the control information PC to the previous state.

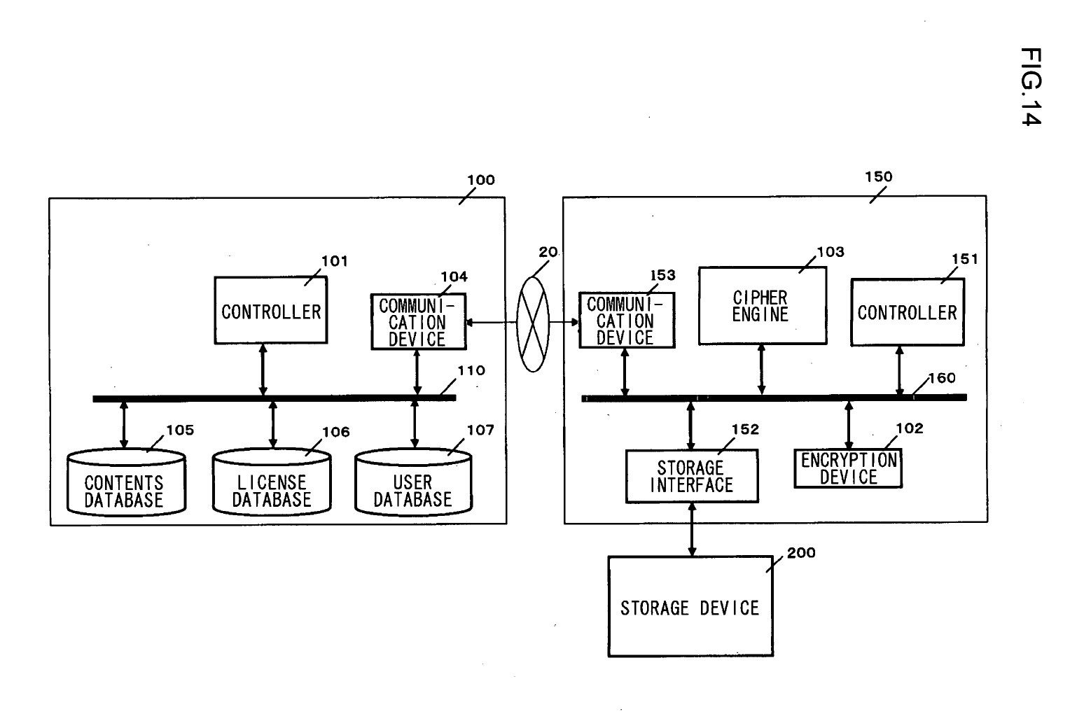

FIG. 14 shows a configuration of a contents distribution system according to a second embodiment. The contents distribution system according to the present embodiment includes the distribution server 100 for distributing contents, the terminal device 150 for receiving the contents, and the storage device 200 for storing the contents provided to the terminal device 150. With such a configuration, the distribution server 100 and the terminal device 150 are connected to the Internet 20 which is an example of networks, through the communication devices 104 and 153.

The contents distribution system according to the present embodiment has generally the same configuration as that of the first embodiment, except for the terminal device 150 including the encryption device 102 and the cipher engine 103, instead of the distribution server 100 including these devices according to the first embodiment.

Furthermore, in order to ensure the security of data communication between the distribution server 100 and the user terminal device 150, data communication between the distribution server 100 and the user terminal device 150 is protected with sufficient security according to SSL or a proprietary digital contents management method stipulated by the distribution provider. This enables the present embodiment to operate in the same way as with the first embodiment.

As described above, description has been made regarding the embodiments according to the present invention. The above-described embodiments have been described for exemplary purposes only, and are by no means intended to be interpreted restrictively. Rather, it can be readily conceived by those skilled in this art that various modifications may be made by making various combinations of the aforementioned components or the aforementioned processing, which are also encompassed in the technical scope of the present invention.

For example, while description has been made in the aforementioned embodiments regarding arrangements in which the cipher engine includes separate functional blocks for the encryption function and the decryption function, respectively. Also an arrangement may be made in which such functional blocks may share the circuit on a component basis. This enables a reduced circuit scale, thereby reducing the size of the system and power consumption thereof.

With the present invention, various modifications may be made as appropriate within the scope of the technical idea of the present invention as laid forth in the appended claims.

What is claimed is:

1. A content reproducing device for decrypting and reproducing encrypted content data using content usage right information containing a content key for decrypting the encrypted content data stored in a storage device, said content reproducing device comprising:
an interface controlling transmission/reception of data to/from said storage device;
a content decryption unit for decrypting said encrypted content data using the content key contained in said content usage right information;
a content key output unit for receiving said content usage right information from said storage device, and outputting said content key contained in said content usage right information to said content decryption unit;
a log storage unit for storing status information which indicates a use state of said content usage right information; and
a determining unit for acquiring elapsed time for which said encrypted content data has been decrypted by said content decryption unit using said content key, or elapsed time for which said content data, which has been decrypted by said content decryption unit using said content key, has been reproduced, determining whether or not said content key has been used based upon said elapsed time thus acquired, and updating status information stored in said log storage unit based upon determination results.

2. A content reproducing device according to claim 1, further including an elapsed-time measurement unit for measuring said elapsed time and notifying said determining unit of said elapsed time,
wherein said elapsed-time measuring unit measures elapsed time from start of decryption or reproduction processing after output of said content key from said content key output unit to said content decryption unit,
and wherein in a case that said elapsed time has exceeded a predetermined period of time, said determining unit determines that said content key has been used.

3. A content reproducing device according to claim 1, further including an elapsed-time measurement unit for measuring said elapsed time and notifying said determining unit of said elapsed time,
wherein said elapsed-time measurement unit calculates said elapsed time based upon amount of data decrypted by said content decryption unit, or based upon reproduced data amount of the encrypted contents data thus decrypted, and notifies said determining unit of said elapsed time thus calculated,
and wherein in a case that said elapsed time has exceeded a predetermined period of time, said determining unit determines that said content key has been used.

4. A content reproducing device according to claim 2, wherein said predetermined period of time is included in said content usage right information,
and wherein said content key output unit outputs said predetermined period of time included in said content usage right information thus received, to said determining unit.

5. A content reproducing device according to claim 2, wherein said predetermined period of time is set to 45 seconds.

6. A content reproducing device according to claim 1, further including a control unit, wherein in a case that said determining unit has determined that said content key has not been used, said control unit requests said storage device to restore said content usage right information stored in said storage device to a previous state in which said content reproducing device has not yet received said content usage right information.

7. A content reproducing device according to claim 6, wherein in a case that said control unit requests said storage device to restore said content usage right information to a previous state in which said content reproducing device has not yet received said content usage right information, said control unit transmits log information containing said status information stored in said log storage unit to said storage device.

8. A content reproducing device according to claim 7, wherein said control unit transmits a hash value of information containing a shared key shared between said content reproducing device and said storage device, as well as transmitting said log information.

9. A content reproducing device according to claim 6, wherein, upon reception of said content usage right information, said log storage unit stores at least a part of said content usage right information without change,
and wherein in a case that said control unit requests said storage device to restore said content usage right information to a previous state in which said content reproducing device has not yet received said content usage right information, said control unit transmits said content usage right information stored in said log storage unit without change, to said storage device.

10. A content reproducing method for decrypting and reproducing encrypted content data using content usage right information containing a content key for decrypting the encrypted content data stored in a storage device, said content reproducing method comprising:
receiving said content usage right information from said storage device, and decrypting said encrypted content data using said content key contained in said content usage right information thus received;
storing status information which indicates a use state of said content usage right information in a log storage unit; and
acquiring elapsed time for which said encrypted content data has been decrypted using said content key, or elapsed time for which said content data, which has been decrypted using said content key, has been reproduced, determining whether or not said content key has been used based upon said elapsed time thus acquired, and updating status information stored in said log storage unit based upon determination results.

11. A content reproducing method according to claim 10, wherein said elapsed time is measured using a timer from start of decryption or reproduction processing,
and wherein in a case that said elapsed time has exceeded a predetermined period of time, determination is made that said content key has been used.

12. A content reproducing method according to claim 10, wherein said elapsed time is calculated based upon decrypted data amount or reproduced data amount of said encrypted content data thus decrypted,
and wherein in a case that said elapsed time has exceeded a predetermined period of time, determination is made that said content key has been used.

13. A content reproducing method according to claim 11, wherein said predetermined period of time is included in said content usage right information.

14. A content reproducing method according to claim 11, wherein said predetermined period of time is set to 45 seconds.

15. A content reproducing method according to claim 10, wherein in a case that determination has been made that said content key has not been used, said storage device is requested to restore said content usage right information stored therein to a previous state in which said content usage right information has not yet been received.

16. A content reproducing method according to claim 15, wherein in a case that a content reproducing device for decrypting and reproducing said encrypted content data has requested said storage device to restore said content usage right information to a previous state in which said content reproducing device has not yet received said content usage right information, log information containing said status information stored in said log storage unit is transmitted to said storage device.

17. A content reproducing method according to claim 16, wherein said storage device determines whether or not restoration of said content usage right information should be permitted with reference to said log information,
and wherein in a case that determination has been made that restoration should be permitted, said storage device restores said content usage right information to a previous state.

18. A content reproducing method according to claim 17, wherein said storage device also stores status information which indicates a use state of said content usage right information therein,
and wherein said storage device further determines whether or not restoration of said content usage right information should be permitted with reference to said status information stored therein.

19. A content reproducing method according to claim 16, wherein a hash value of information containing a shared key shared between said content reproducing device and said storage device is transmitted to said storage device, in addition to said log information.

20. A content reproducing method according to claim 18, wherein said storage device makes a confirmation whether or not a content reproducing device which has requested restoration of said content usage right information matches a device to which said storage device has transmitted said content usage right information, with reference to said hash value,
and wherein in a case that said confirmation has been made, said storage device restores said content usage right information to s previous state.

21. A content reproducing method according to claim 15, wherein in a case of transmission of said content usage right information from said storage device to said content reproducing device, said storage device stores at least a part of said content usage right information without change,
and wherein in a case that said content reproducing device has requested said storage device to restore said content usage right information to a previous state, said storage device overwrites said content usage right information with said content usage right information stored without change, thereby restoring said content usage right information to a previous state.

22. A content reproducing method according to claim 15, wherein upon reception of said content usage right information, said log storage unit stores at least a part of said content usage right information without change,
and wherein in a case that said storage device has been requested to restore said content usage right information to the state in which said content usage right information has not yet been received, said content usage right information stored in said log storage unit without change is transmitted to said storage device.

23. A content reproducing method according to claim 22, having a function for restoring said content usage right information to a previous state by overwriting said content usage right information with said content usage right information in the previous state.
